(19) United States
(12) Patent Application Publication
(10) Pub. No.: US 2022/0405643 A1
(43) Pub. Date: Dec. 22, 2022

(54) SYSTEM AND METHOD FOR RISK SENSITIVE REINFORCEMENT LEARNING ARCHITECTURE

(71) Applicant: ROYAL BANK OF CANADA, Toronto (CA)

(72) Inventors: Pablo Francisco HERNANDEZ-LEAL, Toronto (CA); Yue GAO, Toronto (CA); Yik Chau LUI, Toronto (CA)

(21) Appl. No.: 17/837,882

(22) Filed: Jun. 10, 2022

Related U.S. Application Data
(60) Provisional application No. 63/209,615, filed on Jun. 11, 2021.

(51) Int. Cl. G06N 20/00

(52) U.S. Cl. CPC G06N 20/00

(57) ABSTRACT

A computer-implemented system and method for training an auomated agent are disclosed. An example system includes: a communication interface; at least one processor; memory in communication with said at least one processor; software code stored in said memory, which when executed causes said system to: instantiate an automated agent that maintains a reinforcement learning neural network and generates, according to outputs of said reinforcement learning neural network, signals for communicating task requests; receive a plurality of states and a plurality of actions for the automated agent; initialize a learning table Q for the automated agent based on the plurality of states and the plurality of actions; compute a plurality of updated learning tables based on the initialized learning table Q using a utility function, the utility function comprising a monotonically increasing concave function; and generate an averaged learning table Q′ based on the plurality of updated learning tables.

### CROSS-REFERENCE TO RELATED APPLICATION

This application claims the benefit of and priority to U.S. provisional patent application No. 63/209,615, filed on Jun. 11, 2021, the entire content of which is herein incorporated by reference.

### FIELD

The present disclosure generally relates to the field of computer processing, and in particular to reinforcement learning architectures in machine learning.

### BACKGROUND

Reinforcement learning can be used to train and deploy computerized agents (hereinafter simply “agents”) in trading markets, however, such application may carry fundamental challenges such as high variance and costly exploration. Moreover, markets are inherently a multi-agent domain having many actors taking actions and changing the environment. To tackle these type of scenarios, agents need to exhibit certain characteristics such as risk-awareness, robustness to perturbations and low learning variance.

### SUMMARY

According to an aspect, there is provided a computer-implemented system for training an automated agent. The system includes a communication interface; at least one processor; memory in communication with the at least one processor; software code stored in the memory, which when executed at the at least one processor causes the system to: instantiate an automated agent that maintains a reinforcement learning neural network and generates, according to outputs of the reinforcement learning neural network, signals for communicating task requests; receive, by way of the communication interface, a plurality of training input data including a plurality of states and a plurality of actions for the automated agent; initialize a learning table Q for the automated agent based on the plurality of states and the plurality of actions; compute a plurality of updated learning tables based on the initialized learning table Q using a utility function, the utility function comprising a monotonically increasing concave function; and generate an averaged learning table Q′ based on the plurality of updated learning tables.

In some embodiments, the automated agent is configured to select an action based on the averaged learning table Q′ for communicating one or more task requests.

In some embodiments, utility function is represented by u(x)=−e^{βx}, β<0.

In some embodiments, computing a plurality of updated learning tables may include: receiving, by way of the communication interface, an input parameter k and a training step parameter T; and for each training step t, where t=1, 2 . . . T: computing an interim learning table \hat{Q} based on the initialized learning table Q; selecting an action aₜ from the plurality of actions based on the interim learning table \hat{Q} and a given state sₜ from the plurality of states; computing a reward rₜ and a next state sₜ₊₁ based on the selected action aₜ; and for at least two values of i, where i=1, 2, . . . , k, computing a respective updated learning table Qⁱ of the plurality of updated learning tables based on (sₜ,aₜ, rₜ, sₜ₊₁) and the utility function.

In some embodiments, the averaged learning table Q′ is computed as

$$\frac{1}{k} {\sum }_{i = 1}^{k} {Q}^{i} .$$

In some embodiments, the utility function is a first utility function and the software code, when executed at the at least one processor, further causes the system to: instantiate an adversarial agent that maintains an adversarial reinforcement learning neural network and generates, according to outputs of the adversarial reinforcement learning neural network, signals for communicating adversarial task requests; initialize an adversarial learning table Q_{A} for the adversarial agent; compute a plurality of updated adversarial learning tables based on the initialized adversarial learning table Q_{A} using a second utility function, the second utility function comprising a monotonically increasing convex function; and generate an averaged adversarial learning table Q_{A}′ based on the plurality of updated adversarial learning tables.

In some embodiments, the adversarial agent is configured to select an adversarial action based on the averaged adversarial learning table Q_{A}′ to minimize a reward for the automated agent.

In some embodiments, the second utility function is represented by u^{A}(x)=−e^{β}^{^{A}}^{x}, β^{A}>0.

In some embodiments, computing a plurality of updated adversarial learning tables may include: receiving, by way of the communication interface, an input parameter k and a training step parameter T; and for each training step t, where t=1, 2 . . . T: computing an interim adversarial learning table \hat{Q}^{A} based on the initialized adversarial learning table Q^{A}; selecting an adversarial action aₜ^{A} based on the interim adversarial learning table \hat{Q}^{A} and a given state sₜ from the plurality of states; computing an adversarial reward rₜ^{A} and a next state sₜ₊₁ based on the selected adversarial action aₜ^{A}; and for at least two values of i, where i=1, 2, . . . , k, computing a respective updated adversarial learning table Qⁱ_{A} of the plurality of updated adversarial learning tables based on (sₜ,aₜ^{A},rₜ^{A},sₜ₊₁) and the second utility function.

In some embodiments, the averaged adversarial learning table Q A′ is computed as

$$\frac{1}{k} {\sum }_{i = 1}^{k} {Q}_{A}^{i} .$$

According to another aspect, there is provided a computer-implemented method of training an automated agent, the method including: instantiating an automated agent that maintains a reinforcement learning neural network and generates, according to outputs of the reinforcement learning neural network, signals for communicating task requests; receiving, by way of the communication interface, a plurality of training input data including a plurality of states and a plurality of actions for the automated agent; initializing a learning table Q for the automated agent based on the plurality of states and the plurality of actions; computing a plurality of updated learning tables based on the initialized learning table Q using a utility function, the utility function comprising a monotonically increasing concave function; and generating an averaged learning table Q′ based on the plurality of updated learning tables.

In some embodiments, the method may further include: selecting an action, by the automated agent, based on the averaged learning table Q′ for communicating one or more task requests.

In some embodiments, utility function is represented by u(x)=−e^{βx}, β<0.

In some embodiments, computing a plurality of updated learning tables may include: receiving, by way of the communication interface, an input parameter k and a training step parameter T; and for each training step t, where t=1, 2 . . . T: computing an interim learning table \hat{Q} based on the initialized learning table Q; selecting an action aₜ from the plurality of actions based on the interim learning table \hat{Q} and a given state sₜ from the plurality of states; computing a reward rₜ and a next state sₜ₊₁ based on the selected action aₜ; and for at least two values of i, where i=1, 2, . . . , k, computing a respective updated learning table Qⁱ of the plurality of updated learning tables based on (sₜ,aₜ, rₜ, sₜ₊₁) and the utility function.

In some embodiments, the averaged learning table Q′ is computed as

$$\frac{1}{k} {\sum }_{i = 1}^{k} {Q}^{i} .$$

In some embodiments, the utility function is a first utility function and the method may further include: instantiating an adversarial agent that maintains an adversarial reinforcement learning neural network and generates, according to outputs of the adversarial reinforcement learning neural network, signals for communicating adversarial task requests; initializing an adversarial learning table Q_{A} for the adversarial agent; computing a plurality of updated adversarial learning tables based on the initialized adversarial learning table Q_{A} using a second utility function, the second utility function comprising a monotonically increasing convex function; and generating an averaged adversarial learning table Q_{A}′ based on the plurality of updated adversarial learning tables.

In some embodiments, the method may further include selecting an adversarial action by the adversarial agent based on the averaged adversarial learning table Q_{A}′ to minimize a reward for the automated agent.

In some embodiments, the second utility function is represented by u^{A} (x)=−e^{β}^{^{A}}^{x}, β^{A}>0.

In some embodiments, computing a plurality of updated adversarial learning tables may include: receiving, by way of the communication interface, an input parameter k and a training step parameter T; and for each training step t, where t=1, 2 . . . T: computing an interim adversarial learning table Q_{A} based on the initialized adversarial learning table Q_{A}; selecting an adversarial action aₜ^{A} based on the interim adversarial learning table Q_{A} and a given state sₜ from the plurality of states; computing an adversarial reward rₜA and a next state sₜ₊, based on the selected adversarial action aₜA; and for at least two values of i, where i=1, 2, . . . , k, computing a respective updated adversarial learning table Qⁱ_{A} of the plurality of updated adversarial learning tables based on (sₜ,aₜ^{A},rₜ^{A},sₜ₊₁) and the second utility function.

In some embodiments, the averaged adversarial learning table Q_{A}′ is computed as

$$\frac{1}{k} {\sum }_{i = 1}^{k} {Q}_{A}^{i} .$$

Other features will become apparent from the drawings in conjunction with the following description.

### BRIEF DESCRIPTION OF DRAWINGS

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is an example schematic diagram of a training system, in accordance with an embodiment.

FIG. 1B is a schematic diagram of an automated agent, in accordance with an embodiment.

FIG. 1C is a schematic diagram of an example neural network maintained at the computer-implemented system of FIG. 1A.

FIG. 2 is an example screen from a lunar lander game, in accordance with an embodiment.

FIG. 3 shows an example risk-averse averaged Q-learning algorithm, in accordance with an embodiment.

FIG. 4 shows an example variance reduced risk-averse Q-learning algorithm, in accordance with an embodiment.

FIG. 5 shows an example risk-averse multi-agent Q-learning algorithm, in accordance with an embodiment.

FIG. 6 shows an example risk-averse adversarial averaged Q-learning algorithm, in accordance with an embodiment.

FIG. 7 shows a directional field plot and a trajectory plot of several RL algorithms, in accordance with an embodiment.

FIG. 8 shows an example risk-averse Q-learning algorithm, in accordance with an embodiment.

FIG. 9 shows an example Nash Q-learning algorithm for an agent, in accordance with an embodiment.

FIGS. 10A and 10B show an example risk-averse adversarial Q-learning algorithm. in accordance with an embodiment.

FIG. 11A shows a directional field plot of a meta-game payoff. in accordance with an embodiment.

FIG. 11B shows a trajectory plot of the meta-game payoff in FIG. 11A, in accordance with an embodiment.

FIG. 12A shows a directional field plot of another meta-game payoff, in accordance with an embodiment.

FIG. 12B shows a trajectory plot of the meta-game payoff in FIG. 12A, in accordance with an embodiment.

FIG. 13 is a schematic diagram of a computing device that implements a training system, in accordance with an embodiment.

### DETAILED DESCRIPTION

Reinforcement learning (RL) is a type of machine technique that enables an agent to learn in an interactive environment by trial and error using feedback from its own actions and experiences, in order to maximize a reward. RL has been applied to a number of fields such as games [5], navigation [4], software engineering [2], industrial design [22], and finance [18]. Each of these applications has inherent difficulties which are long-standing fundamental challenges in RL, such as: limited training time, costly exploration and safety considerations, among others.

In particular, in finance, there are some examples of RL in stochastic control problems such as option pricing [19], market making [29], and optimal execution [24]. An example finance application is trading, where the system is configured to implement trained algorithms capable of automatically making trading decisions based on a set of stored rules computed by a machine [31].

In trading, the environment represents the market (and the rest of the actors). The agent's task is to take actions related to how and how much to trade, and the objective is usually to maximize profit while minimizing risk. There are several challenges in this setting such as partial observability, a large action space, a difficult definition of rewards and learning objectives [31]. In this disclosure, two properties for learning agents in realistic trading market scenarios are considered and implemented: risk assessment and robustness. In some embodiments, one or more RL algorithms are implemented with risk-averse objective functions and variance reduction techniques. In some embodiments, the RL algorithms are implemented to operate in a multi-agent learning environment, and can assume an adversary which may take over and perturb the learning process. These RL algorithms are developed to balance theoretical guarantees with practical use. Additionally, an empirical game theory analysis for multi-agent learning by considering risk-averse payoffs is performed and discussed herein.

Risk assessment is a cornerstone in financial applications. One approach is to consider risk while assessing the performance (profit) of a trading strategy. Here, risk is a quantity related to the variance (or standard deviation) of the profit and it is commonly refereed to as “volatility”. In particular, the Sharpe ratio [27] considers both the generated profit and the risk (variance) associated with a trading strategy. This objective function (Sharpe ratio) is different from traditional RL where the goal is to optimize the expected return, usually, without considerations of risk. There are works that proposed risk-sensitive RL algorithms [21, 12] and variance reduction techniques [1]. The RL algorithms discussed in this disclosure improve upon these works, by further reducing variance, for example, through the combination of using a utility function in updating multiple Q-tables in a Q-learning environment, while also having convergence guarantees and improved robustness via adversarial learning.

Deep RL has been shown to be brittle is many scenarios [15], therefore, improving robustness is important for deploying agents in realistic scenarios, such as for use in trading platforms. A line of work has improved robustness of RL agents via adversarial perturbations [23, 26]. For example, the learning framework or system may assume an adversary (who is also learning) is allowed to take over control at regular intervals. This approach has shown good experimental results in robotics [25].

Trading market can be seen as a multi-agent interaction environment. Therefore, the agents in the RL algorithms may be evaluated from the perspective of game theory. However, it may be too difficult to analyze in standard game theoretic framework since there is no normal form representation (commonly used to analyze games). Fortunately, empirical game theory [35, 38] overcomes this limitation by using the information of several rounds of repeated interactions and assuming a higher level of strategies (agents' policies). These modifications have made possible the analysis of multi-agent interactions in complex scenarios such as markets [7], and multi-agent games [33]. However, these works have not studied the interactions under risk metrics (such as Sharpe ratio), which are explored in this disclosure.

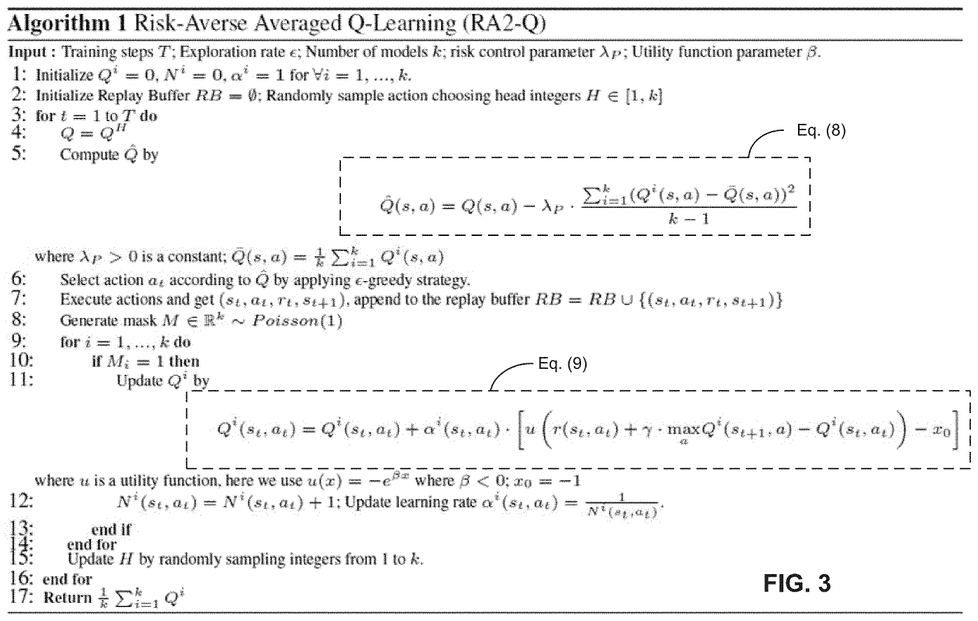

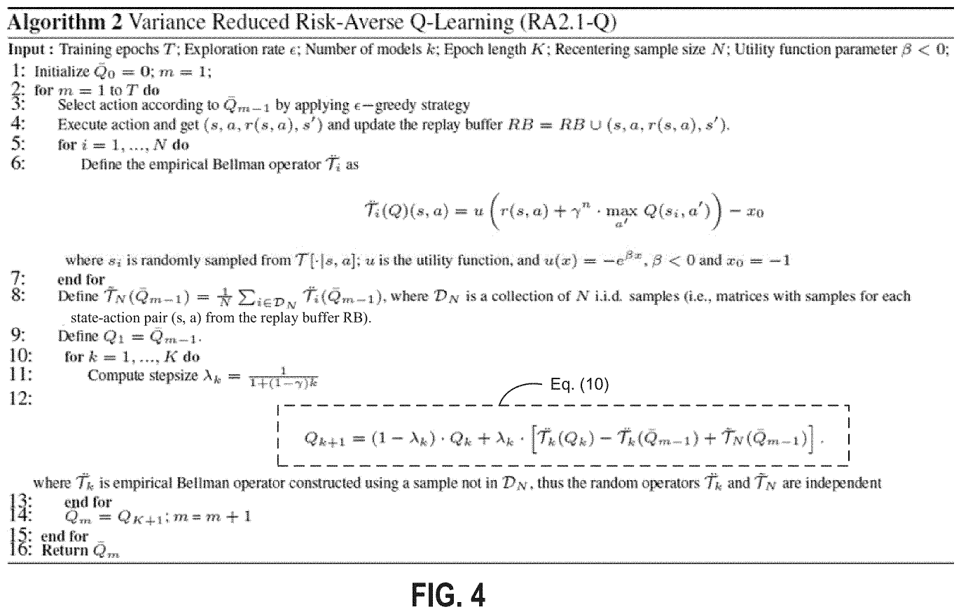

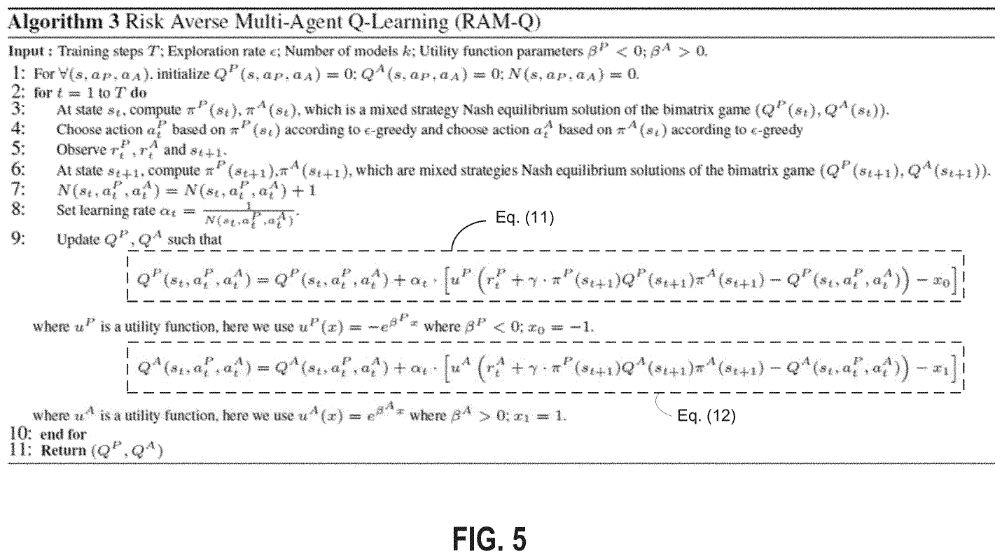

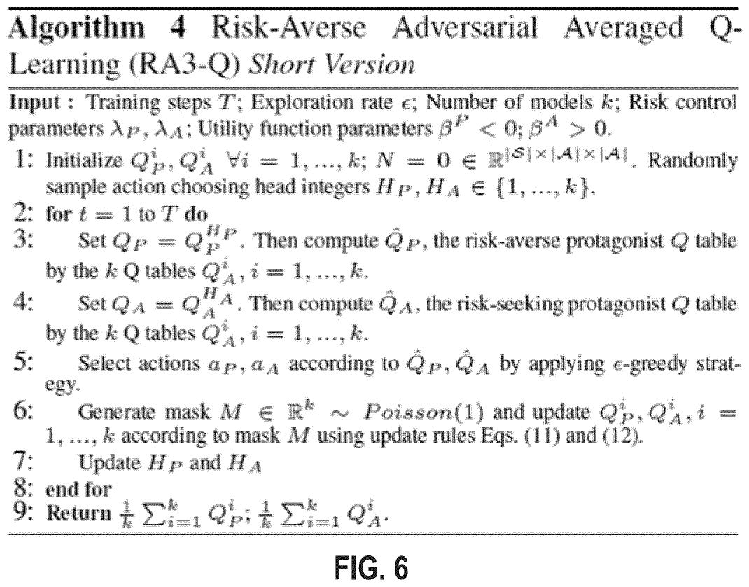

In summary, the RL algorithms disclosed, in some embodiments, combine risk-awareness, variance reduction and robustness techniques. For example, a Risk-Averse Averaged Q-Learning (e.g., RA2-Q shown in FIG. 3) and a Variance Reduced Risk-Averse Q-Learning (e.g., RA2.1-Q shown in FIG. 4) use risk-averse functions and variance reduction techniques. Then, the training framework is further configured to simulate a multi-agent scenario where an adversary that can perturb the learning process, such as, for example, a Risk-Averse Multi-Agent Q-Learning (e.g., RAM-Q in FIG. 5) which is a multi-agent version of adversarial learning with strong assumptions and theoretical guarantees. A Risk-Averse Adversarial Averaged Q-Learning (e.g., RA3-Q in FIG. 6) relaxes those assumptions and proposes a more practical algorithm that keeps the multi-agent adversarial component to improve robustness. A theoretical result is presented using empirical game theory analysis on games with risk-sensitive payoff.

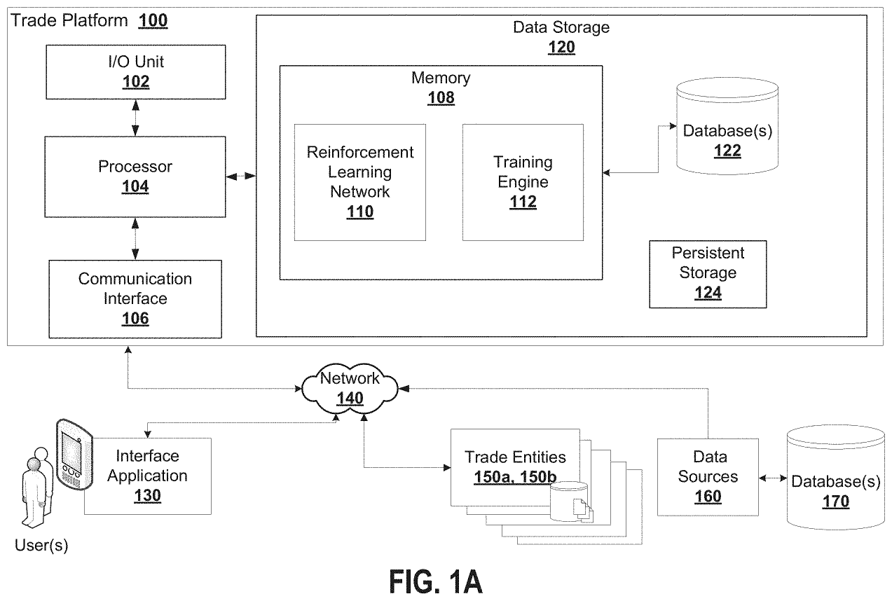

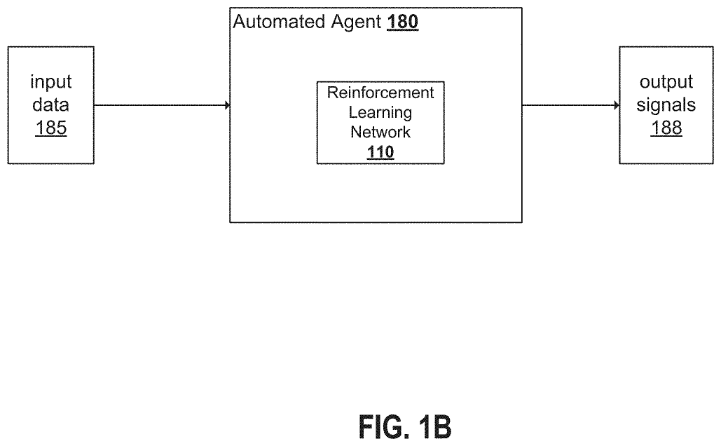

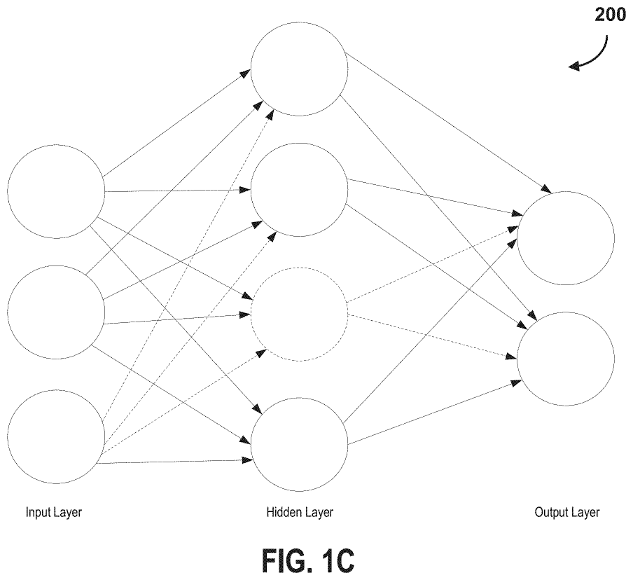

A computer system is described next in which the various RL algorithms may be implemented to train one or more automated agents. FIG. 1A is a high-level schematic diagram of an example computer-implemented system 100 for training an automated agent having a neural network, exemplary of embodiments. The automated agent can be instantiated and trained by system 100 in manners disclosed herein to generate task requests.

As detailed herein, in some embodiments, system 100 includes features adapting it to perform certain specialized purposes, e.g., to function as a trading platform. In such embodiments, system 100 may be referred to as trading platform 100 or simply as platform 100 for convenience. In such embodiments, the automated agent may generate requests for tasks to be performed in relation to securities (e.g., stocks, bonds, options or other negotiable financial instruments). For example, the automated agent may generate requests to trade (e.g., buy and/or sell) securities by way of a trading venue.

Referring now to the embodiment depicted in FIG. 1A, trading platform 100 has data storage 120 storing a model for a reinforcement learning neural network. The model is used by trading platform 100 to instantiate one or more automated agents 180 (e.g., FIG. 1B) that each maintains a reinforcement learning neural network 110 (which may be referred to as a reinforcement learning network 110 or network 110 for convenience).

A processor 104 is configured to execute machine-executable instructions to train a reinforcement learning network 110 through a training engine 112. The training engine can be configured to generate signals based on one or more rewards or inventives to train automated agents 180 to perform desired tasks more optimally, e.g., to minimize and maximize certain performance metrics such as risk or variance.

The platform 100 can connect to an interface application 130 installed on user device to receive input data. Trade entities 150a, 150b can interact with the platform to receive output data and provide input data. The trade entities 150a, 150b can have at least one computing device. The platform 100 can train one or more reinforcement learning neural networks 110. The trained reinforcement learning networks 110 can be used by platform 100 or can be for transmission to trade entities 150a, 150b, in some embodiments. The platform 100 can process trade orders using the reinforcement learning network 110 in response to commands from trade entities 150a, 150b, in some embodiments.

The platform 100 can connect to different data sources 160 and databases 170 to receive input data and receive output data for storage. The input data can represent trade orders. Network 140 (or multiple networks) is capable of carrying data and can involve wired connections, wireless connections, or a combination thereof. Network 140 may involve different network communication technologies, standards and protocols, for example.

The platform 100 can include an I/O unit 102, a processor 104, communication interface 106, and data storage 120. The I/O unit 102 can enable the platform 100 to interconnect with one or more input devices, such as a keyboard, mouse, camera, touch screen and a microphone, and/or with one or more output devices such as a display screen and a speaker.

The processor 104 can execute instructions in memory 108 to implement aspects of processes described herein. The processor 104 can execute instructions in memory 108 to configure a data collection unit, interface unit (to provide control commands to interface application 130), reinforcement learning network 110, training engine 112, and other functions described herein. The processor 104 can be, for example, any type of general-purpose microprocessor or microcontroller, a digital signal processing (DSP) processor, an integrated circuit, a field programmable gate array (FPGA), a reconfigurable processor, or any combination thereof.

As depicted in FIG. 1B, automated agent 180 receives input data 185 (e.g., from one or more data sources 160 or via a data collection unit) and generates output signal 188 according to its reinforcement learning network 110. In some embodiments, the output signal 188 is transmitted to trade entities 150a, 150b for execution of a task. Reinforcement learning network 110 can refer to a neural network that implements reinforcement learning.

FIG. 1C is a schematic diagram of an example neural network 200 according to some embodiments. The example neural network 200 can include an input layer, a hidden layer, and an output layer. The neural network 200 processes input data using its layers based on reinforcement learning, for example.

Reinforcement learning is a category of machine learning that configures agents, such the automated agents 180 described herein, to take actions in an environment to maximize a notion of a reward, and in some embodiments, the reward can be maximized by minimizing risks or variances. The processor 104 is configured with machine executable instructions to instantiate an automated agent 180 that maintains a reinforcement learning neural network 110 (also referred to as a reinforcement learning network 110 for convenience), and to train the reinforcement learning network 110 of the automated agent 180 using a training engine 112. The processor 104 is configured to control the reinforcement learning network 110 to process input data in order to generate output signals. Input data may include trade orders, various feedback data (e.g., rewards), or feature selection data, or data reflective of completed tasks (e.g., executed trades), data reflective of trading schedules, etc. Output signals may include signals for communicating resource task requests, e.g., a request to trade in a certain security. For convenience, a good signal may be referred to as a “positive reward” or simply as a reward, and a bad signal may be referred as a “negative reward” or as a “punishment.

Referring again to FIG. 1A, the interface application 130 interacts with the trading platform 100 to exchange data (including control commands) and generates visual elements for display at user device. The visual elements can represent reinforcement learning networks 110 and output generated by reinforcement learning networks 110.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Data storage devices 120 can include memory 108, databases 122, and persistent storage 124.

The communication interface 106 can enable the platform 100 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The platform 100 can be operable to register and authenticate users (using a login, unique identifier, and password for example) prior to providing access to applications, a local network, network resources, other networks and network security devices. The platform 100 may serve multiple users which may operate trade entities 150a, 150b.

The data storage 120 may be configured to store information associated with or created by the components in memory 108 and may also include machine executable instructions. The data storage 120 includes a persistent storage 124 which may involve various types of storage technologies, such as solid state drives, hard disk drives, flash memory, and may be stored in various formats, such as relational databases, non-relational databases, flat files, spreadsheets, extended markup files, etc.

### Other Practical Applications

As shown in FIG. 1B, automated agent 180 receives input data 185 (e.g., from one or more data sources 160 or via a data collection unit) and generates output signal 188 according to its reinforcement learning network 110. In some embodiments, the output signal 188 can be transmitted to another system, such as a control system, for executing one or more commands represented by the output signal 188.

In some embodiments, once the reinforcement learning network 110 has been trained, it generates output signal 188 reflective of its decisions to take particular actions in response to input data. Input data can include, for example, a set of data obtained from one or more data sources 160, which may be stored in databases 170 in real time or near real time.

As a practical example, an HVAC control system which may be configured to set and control heating, ventilation, and air conditioning units (HVAC) for a building, in order to efficiently manage the power consumption of HVAC units, the control system may receive sensor data representative of temperature data in a historical period. The control system may be implemented to use an automated agent 180 and a trained reinforcement learning network 110 to generate an output signal 188, which may be a resource request command signal 188 indicative of a set value or set point representing a most optimal room temperature based on the sensor data, which may be part of input data 185, representative of the temperature data in present and in a historical period (e.g., the past 72 hours or the past week).

The input data 185 may include a time series data that is gathered from sensors 160 placed at various points of the building. The measurements from the sensors 1160, which form the time series data, may be discrete in nature. For example, the time series data may include a first data value 21.5 degrees representing the detected room temperature in Celsius at time t₁, a second data value 23.3 degrees representing the detected room temperature in Celsius at time t₂, a third data value 23.6 degrees representing the detected room temperature in Celsius at time t₃, and so on.

Other input data 185 may include a target range of temperature values for the particular room or space and/or a target room temperature or a target energy consumption per hour. A reward may be generated based on the target room temperature range or value, and/or the target energy consumption per hour.

In some examples, one or more automated agents 180 may be implemented, each agent 180 for controlling the room temperature for a separate room or space within the building which the HVAC control system is monitoring.

As another example, in some embodiments, a traffic control system which may be configured to set and control traffic flow at an intersection. The traffic control system may receive sensor data representative of detected traffic flows at various points of time in a historical period. The traffic control system may use an automated agent 180 and trained reinforcement learning network 110 to control a traffic light based on input data representative of the traffic flow data in real time, and/or traffic data in the historical period (e.g., the past 4 or 24 hours).

The input data 185 may include sensor data gathered from one or more data sources 160 (e.g. sensors 160) placed at one or more points close to the traffic intersection. For example, the time series data 112 may include a first data value 3 vehicles representing the detected number of cars at time t₁, a second data value 1 vehicles representing the detected number of cars at time t₂, a third data value 5 vehicles representing the detected number of cars at time t₃, and so on.

Based on a desired traffic flow value at tₙ, the automated agent 180, based on neural network 110, may then generate an output signal 188 to shorten or lengthen a red or green light signal at the intersection, in order to ensure the intersection is least likely to be congested during one or more points in time.

As yet another example, the input data 185 may include a set of measured blood pressure values or blood sugar levels in a time period measured by one or more data sources such as medical devices 160. The trained reinforcement learning network 110 may receive the input data 185 from the sensors 160 or a database 170, and generate an output signal 185 representing a predicted data value representing a future blood pressure value or a future blood sugar level. The output signal 185 representing the predicted data value may be transmitted to a health care professional for monitoring or medical purposes.

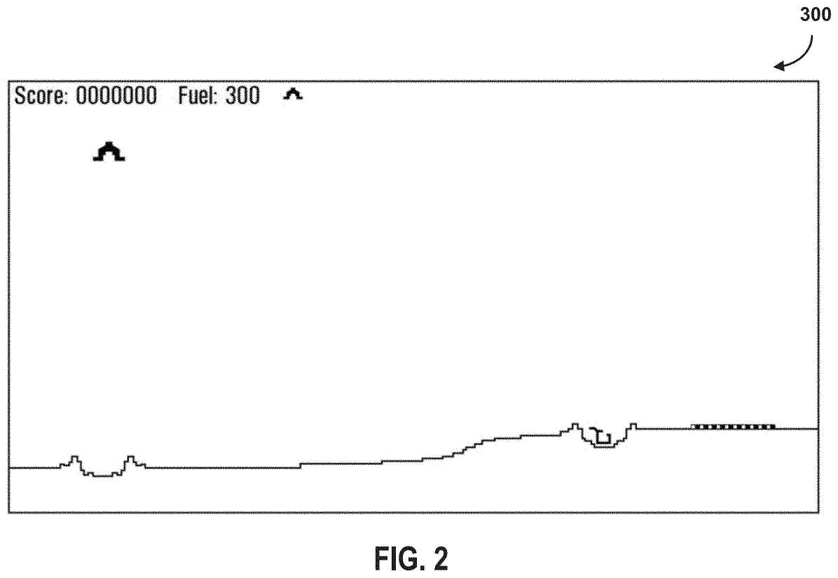

In some embodiments, as another example, an automated agent 180 in system 100 may be trained to play a video game, and more specifically, a lunar lander game 300, as shown in FIG. 2. In this game, the goal is to control the lander's two thrusters so that it quickly, but gently, settles on a target landing pad. In this example, input data 185 provided to an automated agent 180 may include, for example, X-position on the screen, Y-position on the screen, altitude (distance between the lander and the ground below it), vertical velocity, horizontal velocity, angle of the lander, whether lander is touching the ground (Boolean variable), etc.

In some embodiments, the reward may indicate a plurality of objectives including: smoothness of landing, conservation of fuel, time used to land, and distance to a target area on the landing pad. The reward, which may be a reward vector, can be used to train the neural network 110 for landing the lunar lander by the automated agent 180.

### Single-Agent Reinforcement Learning

A Markov Decision Process (MDP) is defined by a set of states [symbol] describing the possible configurations, a set of actions [symbol] and a set of observations [symbol] for each agent. A stochastic policy π_{θ}: [symbol] × [symbol] →[0,1] parameterized by θ produces the next state according to the state transition function [symbol] : [symbol] × [symbol] → [symbol] . The agent obtains rewards as a function of the state and agent's action r: [symbol] × [symbol] → [symbol] , and receives a private observation correlated with the state o: [symbol] → [symbol] . The initial states are determined by a distribution d₀: [symbol] →[0,

[symbol]

### Multi-Agent Reinforcement Learning

In RL, each agent i aims to maximize its own total expected return, e.g., for a Markov game with two agents, for a given initial state distribution d₀, the discounted returns are respectively:

J¹(d₀,π¹,π²)Σₜ₌₀^{∞}γ^{t} [symbol] [rₜ¹|π¹,π²,d₀] (1)

J²(d₀,π¹,π²)Σₜ₌₀^{∞}γ^{t} [symbol] [rₜ²|π¹,π²,d₀] (2)

where γ is a discount factor, rₜ¹, rₜ², t=1, 2, . . . are respectively immediate rewards for agent 1 and agent 2. A Nash equilibrium for Markov game (with two agents) is defined below.

Definition 1 [16] A Nash equilibrium point of game (J¹, J²) is a pair of strategies (π_{*}¹, π_{*}²) such that for ∀s ∈ [symbol] ,

J¹(s,π_{*}¹,π_{*}²)≥J¹(s,π¹,π_{*}²) ∀π¹ (3)

J²(s,π_{*}¹,π_{*}²)≥J²(s,π_{*}¹,π²) ∀π² (4)

Multi-Agent Extension of MDP

A Markov game for N agents is defined by a set of states S describing the possible configurations of all agents, a set of actions [symbol] ₁, . . . , [symbol] _{N} and a set of observations [symbol] ₁, . . . , [symbol] _{N} for each agent. To choose actions, each agent i uses a stochastic policy π_{θ}_{ᵢ}: [symbol] ᵢ× [symbol] ᵢ→[0,1] parameterized by θᵢ, which produces the next state according to the state transition function [symbol] : [symbol] × [symbol] ₁×, . . . × [symbol] _{N}→ [symbol] . Each agent i obtains rewards as a function of the state and agent's action rᵢ: [symbol] × [symbol] ᵢ→ [symbol] , and receives a private observation correlated with the state oᵢ: [symbol] → [symbol] ᵢ. The initial states are determined by a distribution d₀: [symbol] →[0, [symbol] .

Q-learning can use a Q-table to guide an agent to find the best action. A Q-table can be generated based on available [state, action] pairs to the agent, and updated with appropriate values after an action is taken by the agent during a training step or eposide. This Q-table acts as a reference table for the agent to select the most optimal action based on each value in the table. In multi-agent Q-learning, the Q-tables are defined over joint actions for each of the agents. Each agent receives rewards according to its reward function, with transitions dependent on the actions chosen jointly by the set of agents.

### Empirical Game Theory

In some embodiments, the multi-agent behaviours in a trading market can be analyzed using empirical game theory, where a player corresponds to an agent, and a strategy corresponds to a learning algorithm. Then, in a p-player game, players are involved in a single round strategic interaction. Each player i can be configured to select a strategy πⁱ from a set of k strategy Sⁱ={π₁ⁱ, . . . , πₖⁱ} and receive a stochastic payoff Rⁱ(π¹, . . . , π^{p})S¹×S²× . . . ×S^{p}→ [symbol] . The underlying game that is usually studied is rⁱ(πⁱ, . . . , π^{p})= [symbol] [Rⁱ(π¹, . . . , π^{p})]. In general, the payoff of player i can be denoted as pit, and the joint strategy of all players except for player i can be denoted as x⁻ⁱ.

Definition 2 A joint strategy x=(x¹, . . . , x^{p})=(xⁱ, x⁻ⁱ) is a Nash equilibrium if for all i:

$${𝔼}_{π ∼ x} [ {μ}^{i} ( π ) ] = {max}_{{π}^{i}} {𝔼}_{{π}^{- i} ∼ {x}^{- i}} [ {μ}^{i} ( {π}^{i} , {π}^{- i} ) ] \qquad ( 5 )$$

Definition 3 A joint strategy x=(x¹, . . . , x^{p})=(xⁱ, x⁻ⁱ) is an ϵ-Nash equilibrium if for all i:

$${max}_{{π}^{i}} {𝔼}_{{π}^{- i} ∼ {x}^{- i}} [ {μ}^{i} ( {π}^{i} , {π}^{- i} ) ] - {𝔼}_{π ∼ x} [ {μ}^{i} ( π ) ] \leq ϵ \qquad ( 6 )$$

Evolutionary dynamics can be used to analyze multi-agent interactions. An example model is replicator dynamics (RD) [36] which describes how a population evolves through time under evolutionary pressure (in the present disclosure, a population is composed by learning algorithms). RD assumes that the reproductive success is determined by interactions and their outcomes. For example, the population of a certain type increases if they have a higher fitness (in the present disclosure, this means the expected return in certain interaction) than the population average; otherwise that population share will decrease.

To view the dominance of different strategies, it is common to plot the directional field of the payoff tables using the replicator dynamics for a number of strategy profiles x in the simplex strategy space [33].

The embodiments of RL algorithms shown in FIGS. 3 to 6 are mainly situated in the broad area of safe RL [14]. In some embodiments, the robustness of learned policies can be improved by assuming two opposing learning processes: one that aims to disturb the most and another one that tries to control the perturbations [23]. This approach has been recently adapted to work with neural networks in the context of deep RL [26]. Moreover, Risk-Averse Robust Adversarial Reinforcement Learning (RARL) [25] extended this idea by combining with Averaged DQN [1], an algorithm that proposes averaging the previous k estimates to stabilize the training process. RARL trains two agents: protagonist and adversary in parallel. The goal for the protagonist agent can be set to maximize the expected return and minimize the variance of the expected return, while the goal for the adversary agent can be set to minimize the expected return and maximize the variance of the expected return. RARL showed good experimental results, but lacked theoretical guarantees and theoretical insights on the variance reduction and robustness. Multi-agent Q-learning [16] is useful for finding the optimal strategy when there exists a unique Nash equilibrium in general sum stochastic games, and this approach could also be used in adversarial RL.

Wainwright in [34] proposed a variance reduction Q-learning algorithm (V-QL) which can be seen as a variant of the SVRG algorithm in stochastic optimization [17]. Given an algorithm that converges to Q*, one of its iterates Q̅ could be used as a proxy for Q*, and then recenter the ordinary Q-learning updates by a quantity − [symbol] (Q̅)+ [symbol] (Q), where [symbol] is an empirical Bellman operator, [symbol] is the population Bellman operator, which is not computable, but an unbiased approximation of it could be used instead. This algorithm is shown to be convergent and enjoys minimax optimality up to a logarithmic factor.

In some embodiments, risk-averse objective functions [21] can be combined with the Q-learning algorithm to reduce variance and risk, as elaborated below.

### Risk Averse Q-Learning

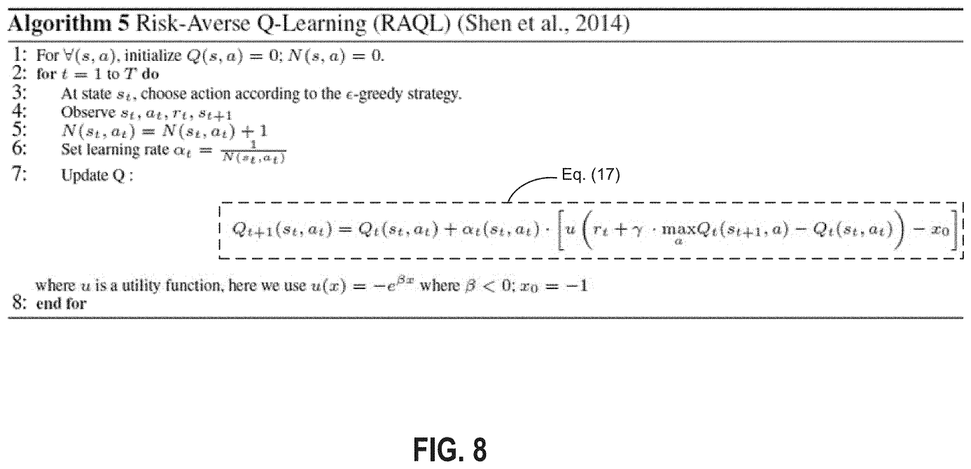

Shen in [28] proposed a Q-learning algorithm that is shown to converge to the optimal of a risk-sensitive objective function. In [28], the training scheme is the same as Q-learning, except that in each iteration, a utility function is applied to a temporal difference (TD) error (see e.g., Algorithm 5 in FIG. 8, further elaborated in the Discussion section below). Generally speaking, a TD error function reports back the difference between an estimated reward and the actual reward received at any given state. The larger the error, the larger the difference between the expected and actual reward.

In order to optimize the expected return as well as minimize the variance of the expected return, an expected utility of the return can be used as the objective function instead:

$${\tilde{J}}_{π} = \frac{1}{β} {𝔼}_{π} [ exp ( β {\sum }_{t = 0}^{∞} {γ}^{t} {r}_{t} ) ] . \qquad ( 7 )$$

By a straightforward Taylor expansion, Eq.(7) above yields:

$$𝔼 [ {\sum }_{t = 0}^{∞} {γ}^{t} {r}_{t} ] + \frac{β}{2} 𝕍ar [ {\sum }_{t = 0}^{∞} {γ}^{t} {r}_{t} ] + O ( {β}^{2} )$$

where when β<0 the objective function is risk-averse, when β=0 the objective function is risk-neutral, and when β>0 the objective function is risk-seeking.

By applying a monotonically increasing concave utility function u(x)=−exp(βx) where β<0 to the TD error, Algorithm 5 (see e.g., FIG. 8) converges to the optimal point of Eq. (7). Hence, it can be shown that:

Theorem 1 (Theorem 3.2, [28]) Running Algorithm 5 from an initial Q table, Q→Q* with probability (w.p.) 1, where Q* is the unique solution to

$${𝔼}_{{s}^{′}} [ u ( r , s , a ) + γ \cdot {max}_{a} {Q}^{*} ( {s}^{′} , a ) - {Q}^{*} ( s , a ) ) ] - {x}_{0} = 0$$

∀(s, a), where s′ is sampled from [symbol] [·|s,a], and the corresponding policy π* of Q* satisfies \tilde{J}_{π}_{^{*}}≥\tilde{J}_{π} ∀π.

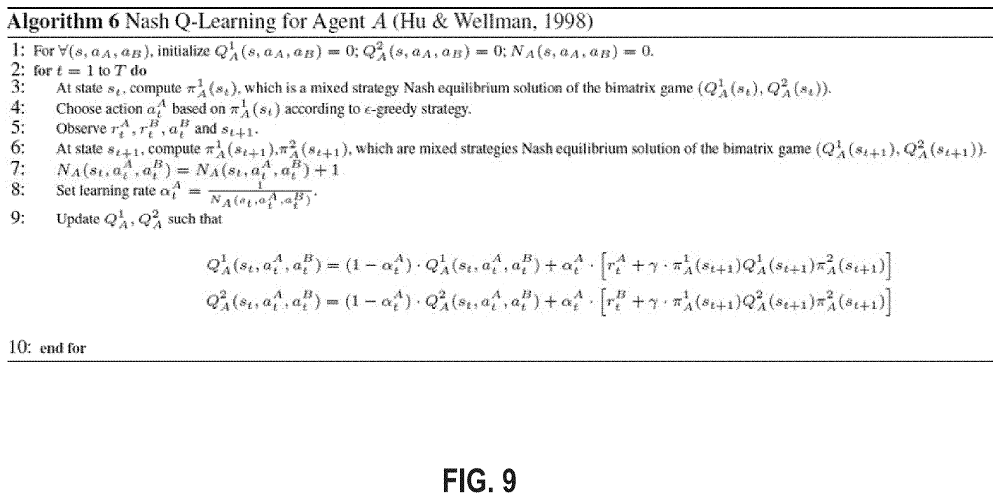

### Multi-Agent Q-Learning

[16] proposed Nash-Q, a Multi-Agent Q-learning algorithm (e.g., Algorithm 6 in FIG. 9 and further elaborated in Discussion section below) in the framework of general-sum stochastic games. When there exists a unique Nash equilibrium in the game, this algorithm is useful for finding the optimal strategy. Nash-Q assumes an agent can observe the other agent's immediate rewards and previous actions during learning. Each learning agent maintains two Q-tables, one for its own Q values, and one for the other agents' Q values. [16] showed that under strong assumptions (e.g., Assumption B.3 in Discussion section below), Algorithm 6 converges to the Nash Equilibrium.

### Example Embodiments

In some example embodiments, a computer-implemented system for training an automated agent may include: a communication interface; at least one processor; memory in communication with the at least one processor; software code stored in the memory, which when executed at the at least one processor causes the system to: instantiate an automated agent that maintains a reinforcement learning neural network and generates, according to outputs of the reinforcement learning neural network, signals for communicating task requests; receive, by way of the communication interface, a plurality of training input data including a plurality of states and a plurality of actions for the automated agent; initialize a learning table Q for the automated agent based on the plurality of states and the plurality of actions; compute a plurality of updated learning tables based on the initialized learning table Q using a utility function, the utility function comprising a monotonically increasing concave function; and generate an averaged learning table Q′ based on the plurality of updated learning tables.

In some embodiments, the automated agent is configured to select an action based on the averaged learning table Q′ for communicating one or more task requests.

In some embodiments, utility function is represented by u(x)=−e^{βx}, β<0.

In some embodiments, computing a plurality of updated learning tables may include: receiving, by way of the communication interface, an input parameter k and a training step parameter T; and for each training step t, where t=1, 2 . . . T: computing an interim learning table \hat{Q} based on the initialized learning table Q; selecting an action aₜ from the plurality of actions based on the interim learning table \hat{Q} and a given state sₜ from the plurality of states; computing a reward rₜ and a next state sₜ₊₁ based on the selected action aₜ; and for at least two values of i, where i=1, 2, . . . , k, computing a respective updated learning table Qⁱ of the plurality of updated learning tables based on (sₜ,aₜ, rₜ, sₜ₊₁) and the utility function.

In some embodiments, the averaged learning table Q′ is computed as

$$\frac{1}{k} {\sum }_{i = 1}^{k} {Q}^{i} .$$

In some embodiments, the utility function is a first utility function and the software code, when executed at the at least one processor, further causes the system to: instantiate an adversarial agent that maintains an adversarial reinforcement learning neural network and generates, according to outputs of the adversarial reinforcement learning neural network, signals for communicating adversarial task requests; initialize an adversarial learning table Q_{A} for the adversarial agent; compute a plurality of updated adversarial learning tables based on the initialized adversarial learning table Q_{A} using a second utility function, the second utility function comprising a monotonically increasing convex function; and generate an averaged adversarial learning table Q_{A}′ based on the plurality of updated adversarial learning tables.

In some embodiments, the adversarial agent is configured to select an adversarial action based on the averaged adversarial learning table Q_{A}′ to minimize a reward for the automated agent.

In some embodiments, the second utility function is represented by u^{A}(x)=−e^{β}^{^{A}}^{x}, β^{A}>0.

In some embodiments, computing a plurality of updated adversarial learning tables may include: receiving, by way of the communication interface, an input parameter k and a training step parameter T; and for each training step t, where t=1, 2 . . . T: computing an interim adversarial learning table \hat{Q}^{A} based on the initialized adversarial learning table Q^{A}; selecting an adversarial action aₜ^{A} based on the interim adversarial learning table \hat{Q}^{A} and a given state sₜ from the plurality of states; computing an adversarial reward rₜ^{A} and a next state sₜ₊₁ based on the selected adversarial action aₜ^{A}; and for at least two values of i, where i=1, 2, . . . , k, computing a respective updated adversarial learning table Qⁱ_{A} of the plurality of updated adversarial learning tables based on (sₜ,aₜ^{A},rₜ^{A},sₜ₊₁) and the second utility function.

In some embodiments, the averaged adversarial learning table Q_{A}′ is computed as

$$\frac{1}{k} {\sum }_{i = 1}^{k} {Q}_{A}^{i} .$$

In some example embodiments, there is a computer-implemented method of training an automated agent, the method may include: instantiating an automated agent that maintains a reinforcement learning neural network and generates, according to outputs of the reinforcement learning neural network, signals for communicating task requests; receiving, by way of the communication interface, a plurality of training input data including a plurality of states and a plurality of actions for the automated agent; initializing a learning table Q for the automated agent based on the plurality of states and the plurality of actions; computing a plurality of updated learning tables based on the initialized learning table Q using a utility function, the utility function comprising a monotonically increasing concave function; and generating an averaged learning table Q′ based on the plurality of updated learning tables.

In some embodiments, the method may further include: selecting an action, by the automated agent, based on the averaged learning table Q′ for communicating one or more task requests.

In some embodiments, the utility function is represented by u(x)=−e^{βx}, β<0.

In some embodiments, computing a plurality of updated learning tables may include: receiving, by way of the communication interface, an input parameter k and a training step parameter T; and for each training step t, where t=1, 2 . . . T: computing an interim learning table \hat{Q} based on the initialized learning table Q; selecting an action aₜ from the plurality of actions based on the interim learning table \hat{Q} and a given state sₜ from the plurality of states; computing a reward rₜ and a next state sₜ₊₁ based on the selected action aₜ; and for at least two values of i, where i=1, 2, . . . , k, computing a respective updated learning table Qⁱ of the plurality of updated learning tables based on (sₜ,aₜ, rₜ, sₜ₊₁) and the utility function.

In some embodiments, the averaged learning table Q′ is computed as

$$\frac{1}{k} {\sum }_{i = 1}^{k} {Q}^{i} .$$

In some embodiments, method may further include: instantiating an adversarial agent that maintains an adversarial reinforcement learning neural network and generates, according to outputs of the adversarial reinforcement learning neural network, signals for communicating adversarial task requests; initializing an adversarial learning table Q_{A} for the adversarial agent; computing a plurality of updated adversarial learning tables based on the initialized adversarial learning table Q_{A} using a second utility function, the second utility function comprising a monotonically increasing convex function; and generating an averaged adversarial learning table Q_{A}′ based on the plurality of updated adversarial learning tables.

In some embodiments, the method may further include selecting an adversarial action by the adversarial agent based on the averaged adversarial learning table Q_{A}′ to minimize a reward for the automated agent.

In some embodiments, the second utility function is represented by u^{A}(x)=−e^{β}^{^{A}}^{x}, β^{A}>0.

In some embodiments, computing a plurality of updated adversarial learning tables may include: receiving, by way of the communication interface, an input parameter k and a training step parameter T; and for each training step t, where t=1, 2 . . . T: computing an interim adversarial learning table \hat{Q}_{A} based on the initialized adversarial learning table Q_{A}; selecting an adversarial action aₜ^{A} based on the interim adversarial learning table \hat{Q}_{A} and a given state sₜ from the plurality of states; computing an adversarial reward rₜ^{A} and a next state sₜ₊₁ based on the selected adversarial action aₜA; and for at least two values of i, where i=1, 2, . . . , k, computing a respective updated adversarial learning table Qⁱ_{A} of the plurality of updated adversarial learning tables based on (sₜ,aₜ^{A},rₜ^{A},sₜ₊₁) and the second utility function.

In some embodiments, the averaged adversarial learning table Q_{A}′ is computed as

$$\frac{1}{k} {\sum }_{i = 1}^{k} {Q}_{A}^{i} .$$

More specifically, a Risk-Averse Averaged Q-Learning (e.g., RA2-Q shown in FIG. 3) and a Variance Reduced Risk-Averse Q-Learning (e.g., RA2.1-Q shown in FIG. 4) use a risk-averse utility functions and reduce variance by training multiple Q tables in parallel. Then, the training framework is further configured to simulate a multi-agent scenario where an adversary that can perturb the learning process, such as, for example, a Risk-Averse Multi-Agent Q-Learning (e.g., RAM-Q in FIG. 5) which is a multi-agent algorithm that assumes an adversary which can perturb the learning process. While RAM-Q is proven to have convergence guarantees, it also needs strong assumptions that might not hold in reality. A Risk-Averse Adversarial Averaged Q-Learning (e.g., RA3-Q in FIG. 6) relaxes those strong assumptions and proposes a more practical algorithm that keeps the multi-agent adversarial component to improve robustness.

Table 1 below briefly summarizes each of the four machine learning models and their respective convergence guarantees (or lack thereof).

TABLE 1
Summary of Four Machine Learning RL Models

| Model | Brief Description | Convergence |
|---|---|---|
| Risk-Averse Averaged | Q-Learning with a utility function; and a | Convergence to optimal of a |
| Q-Learning (RA2-Q) | more stable choice of actions with | risk-averse objective |
| | multiple Q tables | function and reduced |
| | | training variance |
| Variance Reduced Risk- | Use average estimation of multiple | No convergence guarantee |
| Averse Q-Learning | tables in Q updates; and apply utility | |
| (RA2.1-Q) | function in Q updates | |
| Risk-Averse Multiagent | Multi-agent Nash Q-Learning with a | Convergence similar to [16] |
| Q-learning (RAM-Q) | utility function; a risk-averse | |
| | protagonist agent and a risk-seeking | |
| | adversary agent; and multiple Q tables | |
| Risk-Averse Adversarial | Multi-agent Q-Learning with a utility | No convergence guarantee |
| Averaged Q-Learning | function; a risk-averse protagonist | |
| (RA3-Q) | agent and a risk-seeking adversary | |
| | agent; and multiple Q tables | |

### Risk-Averse Averaged Q-Learning (RA2-Q)

FIG. 3 shows an example risk-averse averaged Q-learning algorithm (RA2-Q), in accordance with an embodiment. As shown, input training data may include: a number of training steps T; an exploration rate ϵ; a number of models k; risk control parameter λ_{P}; and a utility function parameter β. A Q-table for the automated agent is initialized, e.g., Qⁱ=0. Other values may be initialized as well: e.g., Nⁱ=0, αⁱ=1 for ∀ⁱ=1, . . . , k. A Replay Buffer may also be set: RB=Ø, and randomly sample action choosing head integers H ∈ [1, k].

From t=1 to T, for each value of t (“while in the t loop”): Q=Q^{H}, the training system may compute an interim Q-table \hat{Q} by

$$\hat{Q} ( s , a ) = Q ( s , a ) - {λ}_{p} \cdot \frac{{\sum }_{i = 1}^{k} {( {Q}^{i} ( s , a ) - \overline{Q} ( s , a ) )}^{2}}{k - 1} \qquad ( 8 )$$

where λ_{P}>0 is a constant; and

$$\overline{Q} ( s , a ) = \frac{1}{k} {\sum }_{i = 1}^{k} {Q}^{i} ( s , a )$$

Next, while in the t loop, the training system may select action aₜ according to \hat{Q} by applying ϵ-greedy strategy, execute the action and get (sₜ,aₜ, rₜ, sₜ₊₁), which can be appended to the replay buffer RB=RB ∪ {(sₜ,aₜ, rₜ, sₜ₊₁)}.

The training system may, while in the t loop, generate a mask M ∈ [symbol] ^{k}˜Poisson(1), and for i=1, . . . , k, for each value of i (“while in the i loop”):

if and when Mᵢ=1, update the learning table Qⁱ by

$${Q}^{i} ( {s}_{t} , {a}_{t} ) = {Q}^{i} ( {s}_{t} , {a}_{t} ) + {α}^{i} ( {s}_{t} , {a}_{t} ) \cdot [ u ( r ( {s}_{t} , {a}_{t} ) + γ \cdot {max}_{a} {Q}^{i} ( {s}_{t + 1} , a ) - {Q}^{i} ( {s}_{t} , {a}_{t} ) ) - {x}_{0} ] \qquad ( 9 )$$

where u is a utility function configured to minimize risks, and x₀=−1.

In some embodiments, the utility function u may be a monotonically increasing concave function in order to minimize risks (and maximize reward) for the automated agent. For example, an example utility function u(x) can be:

If x<=0, u(x)=0.5x; or

If x>0, u(x)=0.1x.

For another example, the utility function u may be u(x)=−e^{βx} where β<0.

Next, while in the i loop, the training system may update Nⁱ by Nⁱ (sₜ,aₜ)=Nⁱ (sₜ,aₜ)+1; update learning rate

$${α}^{i} ( {s}_{t} , {a}_{t} ) = \frac{1}{{N}^{i} ( {s}_{t} , {a}_{t} )} .$$

Outside of the i loop but still while in the t loop, the training system may update H by randomly sampling integers from 1 to k.

Once outside of the t loop, the training system may generate the averaged Q-learning table

$${Q}^{′} = \frac{1}{k} {\sum }_{i = 1}^{k} {Q}^{i} .$$

With Algorithm 5, even though the convergence to the optimal of risk-sensitive objective function is in theory probable with a probability of 1, the proof assumes visiting every state infinitely many times whereas the actual training time is finite. The RA2-Q algorithm above can reduce the training variance further by choosing more risk-averse actions during the finite training process.

The RA2-Q algorithm trains multiple Q tables in parallel and reduces training variance by averaging multiple Q tables in the update. Moreover, in order to obtain convergence guarantee, k Q tables are trained and updated in parallel using Eq. (9) above as the update rule. To select more stable actions, the sample variance of k Q tables can be used as an approximation to the true variance and then a risk-averse \hat{Q} table (e.g., an interim Q-table) can be computed. The risk-averse Q table can then be used to select actions.

The objective function here is Eq. (7), and it can be shown that RA2-Q algorithm (also known as Algorithm 1) also converges to the optimal.

Theorem 2 Running RA2-Q algorithm for an initial Q table, then for all i ∈ {1, . . . , k}, Qⁱ→Q* w.p. 1, hence the returned table

$$\frac{1}{k} {\sum }_{i = 1}^{k} {Q}^{i} \to {Q}^{*} w . p \text{.1} ,$$

where Q* is the unique solution to

$${𝔼}_{{s}^{′}} [ u ( r ( s , a ) + γ \cdot {max}_{a} {Q}^{*} ( {s}^{′} , a ) - {Q}^{*} ( s , a ) ) ] - {x}_{0} = 0$$

for all (s, a), where s′ is sampled from [symbol] [·|s, a], and the corresponding policy π* of Q* satisfies \tilde{J}_{π*}≥\tilde{J}_{π} ∀π.

Theorem 2 follows directly from Theorem 1 (e.g., see Discussion section below for details).

### Variance Reduced Risk-Averse Q-Learning (RA2.1-Q)

FIG. 4 shows an example variance reduced risk-averse Q-learning algorithm (RA2.1-Q), in accordance with an embodiment. The input data include: training epochs T; exploration rate E; number of models k; epoch length K; recentering sample size N; and utility function parameter β<0. The training system can Initialize a number of values: Q̅₀=0; m=1.

From m=1 to T for each value of m (“while in the m loop”): the training system selects an action according to Q̅ₘ₋₁ by applying ϵ-greedy strategy, execute the action and get (s,a,r(s,a),s′), update the replay buffer RB=RB ∪ (s,a,r(s,a),s′).

While in the m loop, from i=1, . . . , N for each value of i (“while in the i loop”): the system defines the empirical Bellman operator [symbol] ᵢ as

$${\ddot{𝒥}}_{i} ( Q ) ( s , a ) = u ( r ( s , a ) + γ \cdot {max}_{{a}^{′}} Q ( {s}_{i} , {a}^{′} ) ) - {x}_{0}$$

where sᵢ is randomly sampled from [symbol] [·|s,a]; u is the utility function, and and x₀=−1.

In some embodiments, the utility function u may be a monotonically increasing concave function in order to minimize risks (and maximize reward) for the automated agent. For example, an example utility function u(x) can be:

If x<=0, u(x)=0.5x; or

If x>0, u(x)=0.1x.

For another example, the utility function u may be u(x)=−e^{βx} where β<0.

Once outside of the i loop, the system defines

$${\tilde{𝒥}}_{N} ( {\overline{Q}}_{m - 1} ) = \frac{1}{N} {\sum }_{i ∈ {𝒟}_{N}} {\ddot{𝒥}}_{i} ( {\overline{Q}}_{m - 1} ) ,$$

where [symbol] _{N} is a collection of N i.i.d. samples (i.e., matrices with samples for each state-action pair (s,a) from RB). Define Q₁=Q̅ₘ₋₁.

From k=1, . . . , K for each value of k (“while in the k loop”): the system computes stepsize

$${λ}_{k} = \frac{1}{1 + ( 1 - γ ) k}$$

and

Qₖ₊₁=(1−λₖ)·Qₖ+λₖ·[ [symbol] k(Qₖ)− [symbol] ₖ(Q̅ₘ₋₁)+ [symbol] _{N}(Qₘ₋₁)] (10)

where [symbol] ₖ is empirical Bellman operator constructed using a sample not in [symbol] _{N}, thus the random operators [symbol] ₖ and [symbol] _{N} are independent.

Once outside of the k loop: Q̅ₘ=Q_{K+1}; m=m+1. Then once outside of the m loop, the system returns Q̅ₘ.

[34] proposed Variance Reduced Q-learning which trains multiple Q tables in parallel and uses the averaged Q table in the update rule. It is shown that it guarantees a convergence rate which is minimax optimal. The RA2.1-Q algorithm improves upon [34] by applying a utility function to the TD error during Q updates for the purpose of further reducing variance. To select more stable actions during training, the sample variance of k Q tables are used as an approximation to the true variance and a risk-averse \hat{Q} table is computed. The risk-averse \hat{Q} table can be used to select actions.

### Multi-Agent Risk-Averse Q-Learning (RAM-Q)

FIG. 5 shows an example risk-averse multi-agent Q-learning (RAM-Q) algorithm, in accordance with an embodiment. The input data may include: training steps T; exploration rate ϵ; number of models k; utility function parameters β^{P}<0; β^{A}>0.

For ∀(s,a_{P},a_{A}), the system can initialize Q^{P}(s,a_{P},a_{A})=0; Q^{A}(s,a_{P},a_{A})=0; N(s,a_{P},a_{A})=0.

From t=1 to T, for each value of t (“while in the t loop”): at state sₜ, the system computes π^{P}(sₜ), π^{A}(sₜ), which is a mixed strategy Nash equilibrium solution of the bimatrix game (Q^{P}(sₜ), Q^{A}(sₜ)). The system (or the automated agent) selects an action aₜ^{P} based on π^{P}(sₜ) according to ϵ-greedy strategy and selects an adversarial action at based on π^{A}(sₜ) according to ϵ-greedy strategy. The system observes and computes rₜ^{P}, rₜ^{A} and sₜ₊₁.

While in the t loop, at state sₜ₊₁, the system computes π^{P} (sₜ₊₁), π^{A}(sₜ₊₁), which are mixed strategies Nash equilibrium solutions of the bimatrix game (Q^{P}(sₜ₊₁), Q^{A}(sₜ₊₁)) N(sₜ,aₜ^{P},aₜ^{A})=N(sₜ,aₜ^{P},aₜ^{A})+1. The system sets learning rate

$${α}_{t} = \frac{1}{N ( {s}_{t} , {a}_{t}^{P} , {a}_{t}^{A} )} .$$

The system then updates Q^{P}, Q^{A} such that:

Q^{P}(sₜ,aₜ^{P},aₜ^{A})=Q^{P}(sₜ,aₜ^{P},aₜ^{A})+αₜ·[u^{P}(rₜ^{P}+γ·π^{P}(sₜ₊₁)Q^{P}(sₜ₊₁)π^{A}(sₜ₊₁)−Q^{P}(sₜ,aₜ^{P},aₜ^{A}))−x₀] (11)

where u^{P} is a utility function and x₀=−1.

Q^{A}(sₜ,aₜ^{P},aₜ^{A})=Q^{A}(sₜ,aₜ^{P},aₜ^{A})+αₜ·[u^{A}(rₜ^{A}+γ·π^{P}(sₜ₊₁)Q^{A}(sₜ₊₁)π^{A}(sₜ₊₁)−Q^{A}(sₜ,aₜ^{P},aₜ^{A}))−x₁] (12)

where u^{A} is a utility function, x₁=1.

Outside of the t loop, the system then returns (Q^{P}, Q^{A}).

In some embodiments, the utility function u^{P} may be a monotonically increasing concave function in order to minimize risks (and maximize reward) for the automated agent. For example, an example utility function u^{P}(x) can be:

If x<=0, u^{P}(x)=0.5x; or

If x>0, u^{P}(x)=0.1x.

For another example, the utility function u^{P} may be u^{P}(x)=−e^{β}^{^{p}}ₓ where β^{p}<0.

In some embodiments, the utility function u^{A} may be a monotonically increasing convex function in order to maximize risks (and minimize reward). For example, the utility function may be u^{A}(x)=e^{β}^{^{A}}ₓ where β^{A}>0.

In complex scenarios such as financial markets learned RL policies can be brittle. To improve robustness adversarial learning is implemented to a multi-agent learning problem in RAM-Q algorithm.

In the adversarial setting, it is assumed that there are two learning processes happening simultaneously, a main protagonist (P) and an adversary (A): the goal of protagonist is to maximize the total return as well as minimize the variance; the goal of adversary is to minimize the total return of protagonist as well as maximizing the variance. Here, one assumption is that each agent can observe its opponent's immediate reward.

Let rₜ^{p} be the immediate reward received by protagonist at step t, and let rₜ^{A} be the immediate reward received by adversary at step t. Then the objective functions may be chosen as follows:

The objective function for the protagonist is,

$${\tilde{J}}_{π}^{P} = \frac{1}{{β}^{P}} {𝔼}_{π} [ exp ( {β}^{P} {\sum }_{t = 0}^{∞} {γ}^{t} \cdot {r}_{t}^{P} ) ] {β}^{P} < 0 \qquad ( 13 )$$

By a Taylor expansion, Eq. (13) yields:

$${\tilde{J}}_{π}^{P} = 𝔼 [ {\sum }_{t = 0} {γ}^{t} \cdot {r}_{t}^{P} ] + \frac{{β}^{P}}{2} 𝕍ar [ {\sum }_{t = 0} {γ}^{t} \cdot {r}_{t}^{P} ] + O ( {( {β}^{P} )}^{2} ) .$$

Similarly, the objective function for the adversary is,

$${\tilde{J}}_{π}^{A} = \frac{1}{{β}^{A}} {𝔼}_{π} [ exp ( {β}^{A} {\sum }_{t = 0}^{∞} {γ}^{t} {r}_{t}^{A} ) ] {β}^{A} > 0 \qquad ( 14 )$$

and by Taylor expansion, Eq. (14) yields,

$${\tilde{J}}_{π}^{A} = 𝔼 [ {\sum }_{t = 0} {γ}^{t} \cdot {r}_{t}^{A} ] + \frac{{β}^{A}}{2} 𝕍ar [ {\sum }_{t = 0} {γ}^{t} \cdot {r}_{t}^{A} ] + O ( {( {β}^{A} )}^{2} ) .$$

Then the following guarantee holds:

Theorem 3 If the two-agent game (\tilde{J}^{P},\tilde{J}^{A}) has a Nash equilibrium solution, then running the RAM-Q algorithm from initial Q tables Q^{P}, Q^{A} will converge to Q_{P}* and Q_{A}* w.p. 1. s.t. the Nash equilibrium solution (π_{*}^{P}, π_{*}^{A}) for the bimatrix game (Q_{P}*, Q_{A}*) is the Nash equilibrium solution to the game (\tilde{J}_{π}^{P},\tilde{J}_{π}^{A}), and the equilibrium payoff are \tilde{J}^{P}(s,π_{*}^{P},π_{*}^{A}), \tilde{J}^{A}(s,π_{*}^{P},π_{*}^{A}).

Although the RAM-Q algorithm gives a solid convergence guarantee, it suffers from drawbacks like expensive computational cost and idealized assumptions, e.g., in trading markets, there may not exist a Nash equilibrium to (\tilde{J}^{P},\tilde{J}^{A}), and during the training process, assumptions about the Nash equilibrium (e.g., Assumption B.3 in Discussion section below) may break [8]. Hence, another algorithm RA3-Q is developed, which relaxes these assumptions (likely at the expense of loosing theoretical guarantees) while enhancing robustness and performing well in reality.

### Risk-Averse Adversarial Averaged Q-Learning (RA3-Q)

FIG. 6 shows an example risk-averse adversarial averaged Q-learning (RA3-Q) algorithm, in accordance with an embodiment. The input data includes: training steps T; exploration rate ϵ; number of models k; risk control parameters λ_{P},λ_{A}; and utility function parameters β^{P}<0; β^{A}>0.

The training system can Initialize Q_{P}ⁱ, Q_{A}ⁱ ∀i=1, . . . , k; N=0 ∈ [symbol] . The system then randomly samples action choosing head integers H_{P}, H_{A} ∈ {1, . . . , k}.

From t=1 to T, for each value oft (“while in the t loop”): the system sets Q_{P}=Q_{P}^{H}^{_{P}}, then computes \hat{Q}_{P}, the risk-averse protagonist Q table by the k Q tables Q_{A}ⁱ, i=1, . . . , k. The system also sets Q_{A}=Q_{A}^{H}^{_{A}}, then computes \hat{Q}_{A}, the risk-seeking protagonist Q table by the k Q tables Qⁱ_{A}, i=1, . . . , k.

Next, the system selects actions a_{P}, a_{A} according to \hat{Q}_{P}, \hat{Q}_{A} by applying ϵ-greedy strategy and generates Poisson mask M ∈ [symbol] ^{k}˜Poisson(1). The system updates Qⁱ_{P}, Qⁱ_{A}, i=1, . . . , k according to mask M using update rules Eq. (11) and Eq. (12). The system then updates H_{P} and H_{A}.

Once outside of the t loop, the system returns

$$\frac{1}{k} {\sum }_{i = 1}^{k} {Q}_{P}^{i} and \frac{1}{k} {\sum }_{i = 1}^{k} {Q}_{A}^{i} .$$

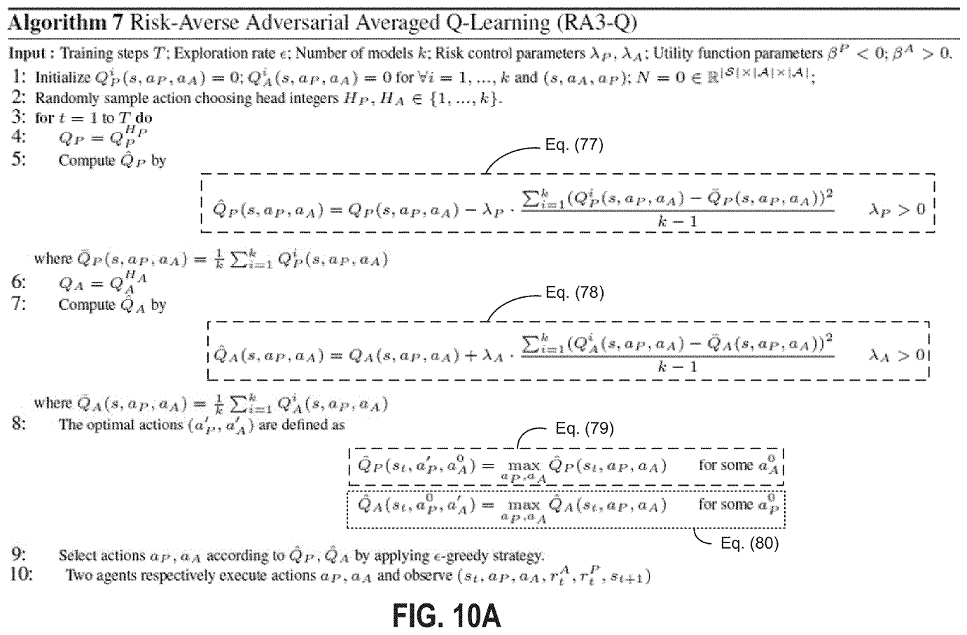

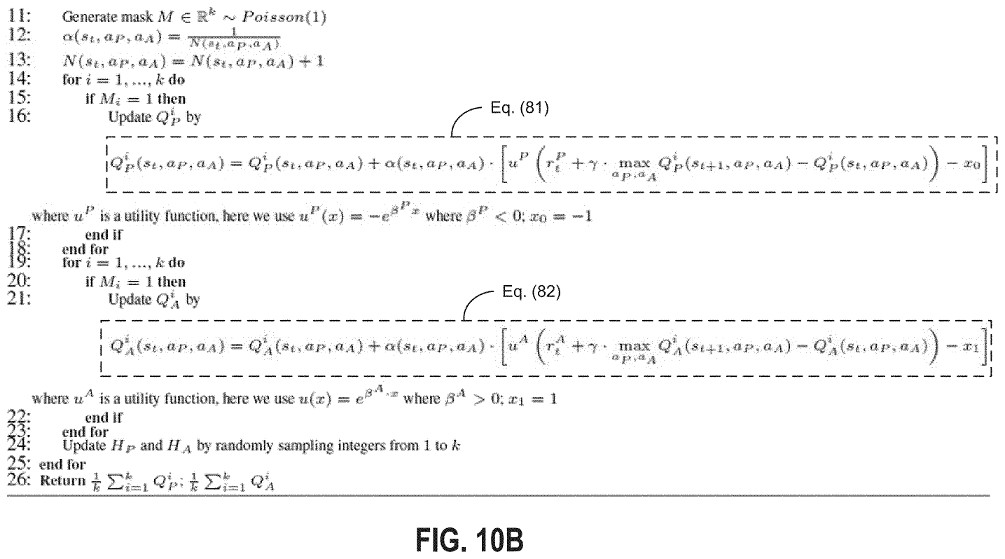

In RA3-Q, the objective function for the protagonist agent is Eq. (13), and the objective function for the adversary agent is Eq. (14). In order to optimize \tilde{J}^{P} and \tilde{J}^{A}, utility functions are applied to TD errors when updating Q tables, and training multiple Q tables in parallel is used to select actions with low variance. The full version of RA3-Q is Algorithm 7 in FIGS. 10A and 10B.

RA3-Q combines (i) risk-averse using utility functions, (ii) variance reduction by having multiple Q tables, and (iii) robustness by adversarial learning. Intuitively, as the adversary is getting stronger, the protagonist experiences harder challenges, thus enhancing robustness. Compared to RAM-Q, where the returned policy (π^{P},π^{A}) is a Nash equilibrium of the (\tilde{J}^{P},\tilde{J}^{A}), RA3-Q does not have a convergence guarantee, however, it has several practical advantages including computational efficiency, simplicity (e.g., no strong assumptions) and more stable actions during training. For a longer discussion see Discussion section, below.

Running RA3-Q from an initial Q table,

$$\frac{1}{k} {\sum }_{i = 1}^{k} {Q}_{P}^{i} \to {Q}^{P *} w . p \text{.1} ,$$

where Q^{P}* is a solution to

$${𝔼}_{{s}_{t} , {a}_{P} , {a}_{A}} [ {u}^{P} ( {r}_{t}^{P} + γ \cdot {max}_{a} {Q}^{P *} ( {s}_{t + 1} , {a}_{P} , {a}_{A} ) - {Q}^{P *} ( {s}_{t} , {a}_{P} , {a}_{A} ) ) ] = {x}_{0}$$

∀(sₜ,a_{P},a_{A}), where sₜ₊₁ is sampled from [symbol] [·|sₜ,a_{P},a_{A}], and the corresponding policy π*_{P} of Q^{P}* satisfies \tilde{J}_{π*}_{_{P}}≥\tilde{J}_{π} ∀π. In addition,

$$\frac{1}{k} {\sum }_{i = 1}^{k} {Q}_{A}^{i} \to {Q}^{A *} w . p \text{.1} ,$$

where Q^{A}* is a solution to

$${𝔼}_{{s}_{t} , {a}_{P} , {a}_{A}} [ {u}^{A} ( {r}_{t}^{A} + γ \cdot {max}_{a} {Q}^{P *} ( {s}_{t + 1} , {a}_{P} , {a}_{A} ) - {Q}^{P *} ( {s}_{t} , {a}_{P} , {a}_{A} ) ) ] = {x}_{1}$$

∀(sₜ,a_{P},a_{A}). Where sₜ₊₁ is sampled from [symbol] [·|sₜ,a_{P},a_{A}]. And the corresponding policy π*_{A} of Q^{A}* satisfies \tilde{J}_{π*}_{_{A}}^{A}≥\tilde{J}_{π}^{A} ∀π.

### Performance Evaluated by Empirical Game Theory

When the environment is populated by many learning agents, empirical game theory (EGT) may be used to evaluate the performance of the agents.

In EGT each agent is a player involved in rounds of strategic interaction (games). By meta-game analysis, we can evaluate the superiority of each strategy. Our contribution is to theoretically prove that the Nash-Equilibrium of risk averse meta-game is an approximation of the Nash-Equilibrium of the population game, to our knowledge, this is the first work doing this type of risk-averse analysis.

In EGT, the dominance of strategies can be visualized by plotting the meta-game payoff tables together with the replicator dynamics. A meta game payoff table could be seen as a combination of two matrices (U|N), where each row Nᵢ contains a discrete distribution of p players over k strategies, and each row yields a discrete profile (n_{π}_{₁}, n_{π}_{ₖ}) indicating exactly how many players play each strategy with Σⱼ n_{π}_{ⱼ}=p. A strategy profile

$$u = ( \frac{{n}_{{π}_{1}}}{p} , … , \frac{{n}_{{π}_{k}}}{p} ) .$$

And each row Rᵢ captures the rewards corresponding to the rows in N.

For example, for a game A with 2 players, and 3 strategies {π₁, π₂, π₃} to choose from, the meta game payoff table could be constructed as follows: in the left side of the table, all of the possible combinations of strategies are listed. If there are p players and k strategies, then there are

$$( \begin{matrix}p + k - 1 \\ p\end{matrix} )$$

rows, hence in game A, there are 6 rows.

Once a meta-game payoff table and the replicator dynamics are obtained, a directional field plot is computed where arrows in the strategy space indicates the direction of flow, or change, of the population composition over the strategies (see Discussion section below for two examples of directional field plots in multi-agent problems).

Previously, [33] showed that for a game rⁱ(πⁱ, . . . , π^{p})= [symbol] [Rⁱ(π¹, . . . , π^{p})], with a meta-payoff (empirical payoff) \hat{r}ⁱ(πⁱ, . . . , η^{p}), the Nash Equilibrium of \hat{r} is an approximation of Nash Equilibrium of r.

Lemma 1 [33] If x is a Nash Equilibrium for the game \hat{r}ⁱ (π¹, . . . , π^{p}), then it is a 2ϵ-Nash equilibrium for the game rⁱ(π¹, . . . , π^{p}), where

$$∈ = {sup}_{π , i} \vert {\hat{r}}^{i} ( π ) - {r}^{i} ( π ) \vert .$$

Lemma 1 implies that if for each player, we can bound the estimation error of empirical payoff, then we can use the Nash Equilibrium of meta game as an approximation of Nash Equilibrium of the game.

As the objective is to consider risk averse payoff to evaluate strategies, instead of

rⁱ(πⁱ, . . . ,π^{p})= [symbol] [Rⁱ(π¹, . . . ,π^{p})],

The following equation

hⁱ(π¹, . . . ,π^{p})= [symbol] [Rⁱ(π1, . . . ,π^{p})]−β· [symbol] ar[Rⁱ(π¹, . . . ,π^{p})]

(where β>0) is chosen as the game payoff.

Moreover, the following equation

$${\hat{h}}^{i} ( {π}^{i} , … , {π}^{p} ) = {\overline{R}}^{i} - β \cdot [ \frac{1}{n - 1} {\sum }_{j = 1}^{n} {( {R}_{j}^{i} - {\overline{R}}^{i} )}^{2} ] \qquad ( 15 )$$

is chosen as meta-game payoff, where

$${\overline{R}}^{i} = \frac{1}{n} {\sum }_{j = 1}^{n} {R}_{j}^{i}$$

and Rⱼⁱ is the stochastic payoff of player i in j-th experiment.

To the inventors' knowledge, there is no previous work on empirical game theory analysis with risk sensitive payoff. Below a theoretical analysis is presented to show that for the risk-averse payoff game, the Nash Equilibrium can still be approximated by a meta game.

Theorem 4 Under Assumption G.4, for a Normal Form Game with p players, and each player i chooses a strategy πⁱ from a set of strategies Sⁱ={π₁ⁱ, . . . , πₖⁱ} and receives a meta payoff hⁱ(π¹, . . . ,π^{p}) (Eq. (15)). If x is a Nash Equilibrium for the game ĥⁱ(π¹, . . . ,π^{p}), then it is a 2ϵ-Nash equilibrium for the game hⁱ(π¹, . . . ,π^{p}) with probability 1-δ if the game is played for n times, where

$$n \geq max \{ - \frac{8 {R}^{2}}{{∈}^{2}} log [ \frac{1}{4} ( 1 - {( 1 - δ )}^{\frac{1}{\vert {s}^{1} \vert \times … \times \vert {s}^{p} \vert \times p}} ) ] , \frac{64 {β}^{2} {ω}^{2} \cdot Γ ( 2 )}{{∈}^{2} [ 1 - {( 1 - δ )}^{\frac{1}{\vert {S}^{1} \vert \times … \times \vert S p \vert \times p}} ]} \} \qquad ( 16 )$$

### Experiments

The experiments are conducted using the open-sourced ABIDES [11] market simulator in a simplified setting. The environment is generated by replaying publicly available real trading data for a single stock ticker (see e.g., https://lobsterdata.com/info/DataSamples.php. The setting includes one non-learning agent that replays the market deterministically [3] and learning agents. The learning agents considered are: RAQL (i.e., Algorithm 5), RA2-Q (i.e., Algorithm 1), RA2.1-Q (i.e., Algorithm 2), and RA3-Q (i.e., Algorithm 4).

A setting similar to existing implementations in ABIDES (see e.g., https://github.com/abides-sim/abides/blob/master/agent/examples/QLearningAgent.py) is used where the state space is defined by two features: current holdings and volume imbalance. Agents take one action at every time step (every second) selecting among: buy/sell with limit price base+i·K, where i ∈ {1, 2, . . . , 6} or do nothing. The immediate reward is defined by the change in the value of the portfolio (mark-to-market) and comparing against the previous time step. The comparisons are in terms of Sharpe ratio, which is a widely used measure in trading markets.

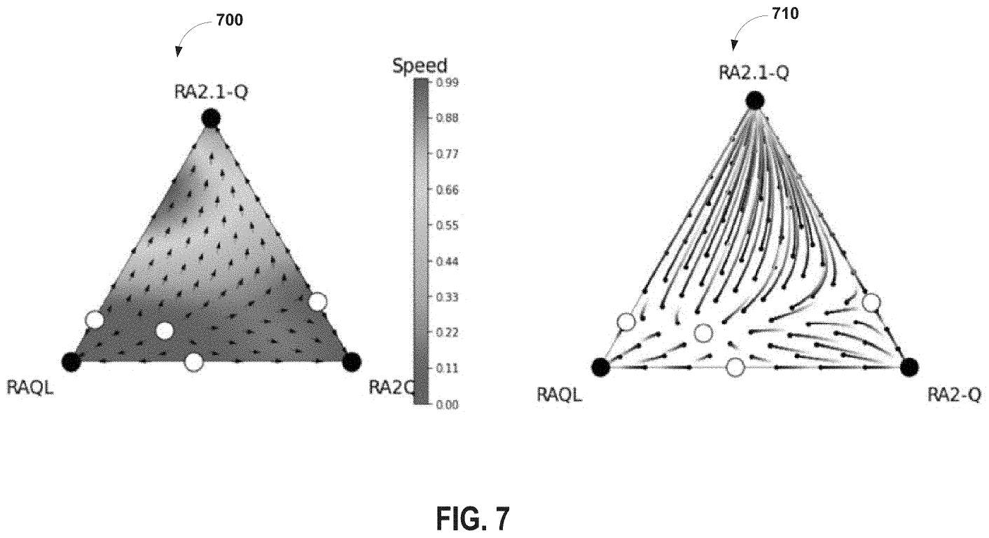

Table 2 below shows the meta-payoff table of a two player-game among three strategies: RAQL, RA2-Q and RA2.1-Q. The results show that the two proposed algorithms RA2-Q and RA2.1-Q obtained better results than RAQL. With those payoffs, the directional plot 700 and the trajectory plot 710 shown in FIG. 7, where black solid circles denote globally-stable equilibria, and the white circles denote unstable equilibria (saddle-points). In the directional plot 700, the plot is colored according to the speed at which the strategy mix is changing at each point; and in the trajectory plot 710, the lines show trajectories for some points over the simplex.

TABLE 2
Meta-payoff of 2 players, 3 strategies, respectively
RAQL, RA2-Q and RA2.1-Q over 80 simulations.
The return here used is Sharpe Ratio.

| Nᵢ₁ | Nᵢ₂ | Nᵢ₃ | Rᵢ₁ | Rᵢ₂ | Rᵢ₃ |
|---|---|---|---|---|---|
| 2 | 0 | 0 | 0.9130 | 0 | 0 |
| 1 | 1 | 0 | 0.7311 | 0.7970 | 0 |
| 0 | 2 | 0 | 0 | 1.0298 | 0 |
| 1 | 0 | 1 | 0.6791 | 0 | 1.0786 |
| 0 | 0 | 2 | 0 | 0 | 2.2177 |
| 0 | 1 | 1 | 0 | 0.7766 | 1.4386 |

Table 2 shows RA2-Q and RA3-Q in terms of robustness. In this setting both agents are trained under the same conditions as a first step. Then in testing phase, two types of perturbations, an adversarial agent (trained within RA3-Q) and a noise agent (i.e., zero-intelligence) are added in the environment. The results are presented in Table 3 below, in terms of Sharpe ratio using cross validation with 80 experiments.

Table 3 shows comparison, again in terms of Sharpe ratio, with two types of perturbations: the trained adversary from RA3-Q is used in testing time, and zero-intelligence agents. It can be seen that RA3-Q obtains better results in both cases due to its enhanced robustness.

TABLE 3

| Algorithim/Setting | Adversarial Perturation | ZI Agents Perturbation |
|---|---|---|
| RA2-Q | 0.5269 | 0.9538 |
| RA3-Q | 0.9347 | 1.0692 |

### Discussion

As mentioned earlier, RA2.1-Q in theory does not a convergence guarantee, however, it obtained good empirical results (better than RAQL and RA2-Q). It is an open question whether RA2.1-Q converges to the optimal of Eq.(7). Furthermore, it may be explored whether RA2.1-Q also enjoys minimax optimality convergence rate up to a logarithmic factor as in [34]. Similarly, RA3-Q does not have a convergence guarantee in the multi-agent learning scenario (when protagonist and adversary agents are learning simultaneously). However, RA3-Q obtained better empirical results than RA2-Q highlighting its robustness. In the text below, it is shown that Eq. (81) or Eq. (82) converges to optimal assuming the policy for the adversary (or protagonist) is fixed (thus, it is no longer a multi-agent learning setting).

In terms of the EGT analysis, the analysis uses a risk-averse measure based on variance (second moment), studying higher moments and other measures may be possible.

In this disclosure, four new different Q-learning algorithms are presented that augment reinforcement learning agents with risk-awareness, variance reduction, and robustness. RA2-Q and RA2.1-Q are risk-averse but use slightly different techniques to reduce variance. RAM-Q and RA3-Q are two algorithms that extend the RL agents by adding an adversarial learning layer which is expected to improve robustness. The theoretical results show convergence results for RA2-Q and RAM-Q; and in the empirical results, RA2.1-Q and RA3-Q obtained better results in a simplified trading scenario.

### Risk-Averse Q-Learning (RAQL) and Proof of Convergence

FIG. 8 shows an example risk-averse Q-learning algorithm (RAQL [28]; Algorithm 5). In particular, the Q-table is updated be Eq. (17) below:

$${Q}_{t + 1} ( {s}_{t} , {a}_{t} ) = {Q}_{t} ( {s}_{t} , {a}_{t} ) + {α}_{t} ( {s}_{t} , {a}_{t} ) \cdot [ u ( {r}_{t} + γ \cdot {max}_{a} {Q}_{t} ( {s}_{t + 1} , a ) - {Q}_{t} ( {s}_{t} , {a}_{t} ) ) - {x}_{0} ] \qquad ( 17 )$$

where u is a utility function, u(x)=−e^{βx} where β<0; x₀=−1.

As proven by [28], Lemma A.2. for the iterative procedure

$${Q}_{t + 1} ( {s}_{t} , {a}_{t} ) = {Q}_{t} ( {s}_{t} , {a}_{t} ) + {α}_{t} ( {s}_{t} , {a}_{t} ) [ u ( {r}_{t} + γ \cdot {max}_{a} {Q}_{t} ( {s}_{t + 1} , a ) - {Q}_{t} ( {s}_{t} , {a}_{t} ) ) - {x}_{0} ] \qquad ( 18 )$$

where aₜ≥0 satisfy that for any (s, a), Σₜ₌₀^{∞}αₜ(s, a)=∞; and Σₜ₌₀^{∞}αₜ²(s, a)<∞, then Qₜ→Q*, where Q* is the solution of the Bellman equation

$$( {H}^{A} {Q}^{*} ) ( s , a ) = α \cdot {𝔼}_{s , a} [ \tilde{u} ( {r}_{t} + γ \cdot {max}_{a} {Q}^{*} ( {s}_{t + 1} , a ) - {Q}^{*} ( s , a ) ) ] + {Q}^{*} ( s , a ) = {Q}^{*} ( s , a ) ∀ ( s , a ) \qquad ( 19 )$$

If Lemma A.2 is true, then it is shown in [28] that the corresponding policy optimizes the objective function Eq. (7).

Before proving convergence in Lemma A.2, a more general update rule is discussed:

qₜ₊₁(i)=(1−αₜ(i))qₜ(i)+αₜ(i)[(Hqₜ)(i)+wₜ(i)] (20)

where i is the independent variable (e.g., in single agent Q learning, it's the state-action pair (s, a)), qₜ ∈ [symbol] ^{d}, H: [symbol] ^{d}→ [symbol] _{d} is an operator, wₜ denotes some random noise term and αₜ is learning rate with the understanding that αₜ(i)=0 if q(i) is not updated at time t. Denote by [symbol] ₜ the history of the algorithm up to time t,

[symbol]

ₜ={q₀(i), . . . ,qₜ(i),w₀(i), . . . ,wₜ(i),α₀(i), . . . , αₜ(i)} (21)

Recall the following essential proposition:

Proposition 1 [6] Let qₜ be the sequence generated by the iteration Eq. (20), if the following assumption is true:

(a). The learning rates αₜ(i) satisfy:

αₜ(i)≥0; Σₜ₌₀^{∞}αₜ(i)=∞; Σₜ₌₀^{∞}αₜ²(i)<∞; ∀i (22)

(b). The noise terms wₜ(i) satisfy
(i) [symbol] [wₜ(i)| [symbol] ₜ]=0 for all i and t;
(ii) there exist constants A and B such that [symbol] [wₜ²(i)| [symbol] ₜ]≤A+B∥qₜ∥² for some norm ∥⋅∥ on [symbol] ^{d}.

(c). The mapping H is a contraction under sup-norm.

Then qₜ converges to the unique solution q* of the equation Hq*=q* with probability 1.

In order to apply Proposition 1, the update rule Eq. (9) is formulated by letting

$${q}_{t + 1} ( s , a ) = ( 1 - \frac{{α}_{t} ( s , a )}{α} ) {q}_{t} ( s , a ) + \frac{{α}_{t} ( s , a )}{α} [ α \cdot u ( {d}_{t} ) - α \cdot {x}_{0} + {q}_{t} ( s , a ) ] where \tilde{u} ( x ) := u ( x ) - {x}_{0} ; {d}_{t} : = {r}_{t} + γ \cdot {max}_{a} {q}_{t} ( {s}_{t + 1} , a ) - {q}_{t} ( s , a ) . \qquad ( 23 )$$

And the following is set:

$$( H {q}_{t} ) ( s , a ) = α \cdot {𝔼}_{s , a} [ \tilde{u} ( {r}_{t} + γ \cdot {max}_{a} {q}_{t} ( {s}_{t + 1} , a ) - {q}_{t} ( s , a ) ) ] + {q}_{t} ( s , a ) \qquad ( 24 )$$

$${w}_{t} ( s , a ) = α \cdot \tilde{u} ( {d}_{t} ) - α \cdot {𝔼}_{s , a} [ \tilde{u} ( {r}_{t} + γ \cdot {max}_{a} {q}_{t} ( {s}^{′} , a ) - {q}_{t} ( s , a ) ) ] \qquad ( 25 )$$

where s′ is sampled from [symbol] [·|s,a].

More explicitly, Hq is defined as

$$( H q ) ( s , a ) = α \cdot {\sum }_{{s}^{′}} 𝒯 [ {s}^{′} \vert s , a ] \cdot \tilde{u} ( r ( s , a ) + γ \cdot {max}_{{a}^{′}} q ( {s}^{′} , {a}^{′} ) - q ( s , a ) ) + q ( s , a ) \qquad ( 26 )$$

Next, it is shown that H is a contraction under sup-norm.

The utility function is assumed to satisfy:

Assumption A.1

i. The utility function u is strictly increasing and there exists some y₀ ∈ [symbol] such that u(y₀)=x₀.

ii. There exist positive constants ϵ, L such that

$$0 < ∈ \leq \frac{u ( x ) - u ( y )}{x - y} \leq L$$

for all x≠y ∈ [symbol] .

Assumption A.1 appears to exclude several important types of utility functions such as the exponential function u(x)=exp(c·x) since it does not satisfy the global Lipschitz. But this can be solved by a truncation when x is very large and by an approximation when x is very close to 0.

In addition, the immediate reward rₜ is assumed to always satisfy:

Assumption A.2 rₜ is uniformly sub-Gaussian over t with variance proxy σ², i.e.,

$$𝔼 [ {r}_{t} ] = 0 \qquad ( 27 )$$

$$\begin{matrix}𝔼 [ exp ( c \cdot {r}_{t} ) ] \leq exp ( \frac{{σ}^{2} {c}^{2}}{2} ) & ∀ c ∈ ℝ\end{matrix} \qquad ( 28 )$$

Proposition 2 Suppose that Assumption A.1 and Assumption A.2 hold and 0<α<min(L⁻¹, 1). Then there exists a real number α̅ ∈ [0,1) such that for all q, q′ ∈ [symbol] ^{d}, ∥Hq−Hq′∥_{∞}≤α∥q−q′∥_{∞}.

$$Proof . Define v ( s ) : = {max}_{a} q ( s , a ) and {v}^{′} ( s ) : = {max}_{a} {q}^{′} ( s , a ) . Thus , \vert v ( s ) - v ' ( s ) \vert \leq {max}_{s , a} \vert q ( s , a ) - q ' ( s , a ) \vert = {‖ q - {q}^{′} ‖}_{∞} \qquad ( 29 )$$

By Assumption A.1, and the monotonicity of ũ, there exists a ξ_{(x,y)} ∈ [ϵ, L] such that ũ(x)−ũ(y)=ξ_{(x,y)}·(x−y). Then the following can be obtained:

$$( H q ) ( s , a ) - ( {Hq}^{′} ) ( s , a ) \qquad ( 30 )$$

$$= {\sum }_{{s}^{′}} 𝒯 [ {s}^{′} \vert s , a ] \cdot \{ {αξ}_{( s , a , {s}^{′} , q , {q}^{′} )} \cdot [ γ v ( {s}^{′} ) - γ {v}^{′} ( {s}^{′} ) - q ( s , a ) + {q}^{′} ( s , a ) ] + ( q ( s , a ) - {q}^{′} ( s , a ) ) \} \qquad ( 31 )$$

$$\leq ( 1 - α ( 1 - γ ) {\sum }_{s} / T [ s ′ \vert s , a ] ⋅ ζ / / ) ‖ q - {q}^{1} {‖}_{∞} \qquad ( 32 )$$

$$\leq ( 1 - α ( 1 - γ ) ε ) ‖ q - {q}^{1} {‖}_{∞} \qquad ( 33 )$$

Hence, α̅=1−α(1−γ)ϵ is the required constant.

Now that it is shown that the requirements (a) and (c) of Proposition 1 hold, it remains to check (b). By Eq.(24), [symbol] [wₜ(s, a)| [symbol] ₜ]=0. Next, proof of (b)(ii) is presented.

$$𝔼 [ {w}_{t}^{2} ( s , a ) \vert {ℱ}_{t} ] = {α}^{2} 𝔼 [ {( ũ ( {d}_{t} ) )}^{2} \vert {ℱ}_{t} ] - {{α}^{2} ( 𝔼 [ \tilde{u} ( {d}_{t} ) \vert {ℱ}_{t} ] )}^{2} \qquad ( 34 )$$

$$\leq {α}^{2} 𝔼 [ {( \tilde{u} ( {d}_{t} ) )}^{2} \vert {ℱ}_{t} ] \qquad ( 35 )$$

By Assumption A.2,

$$𝔼 \vert {r}_{t} \vert < {( 2 σ )}^{\frac{1}{2}} Γ ( \frac{1}{2} ) ,$$

where Γ(⋅) is the Gamma function (see [10] for details). The upper bound for [symbol] [|rₜ|] is denoted as R₁. Then [symbol] [|dₜ|]≤R₁+2∥qₜ∥_{∞}, due to Assumption A.1, it implies that

[symbol]

[|ũ(dₜ)−ũ(0)|]≤ [symbol] [L·dₜ]≤L(R₁+2∥qₜ∥_{∞}) (36)

Hence by triangle inequality,

[symbol]

[|ũ(dₜ)|]≤ũ(0)+LR₁+2L∥qₜ∥_{∞} (37)

And since

(a+b)²≤2a²+2b² ∀a,b∈ [symbol] (38)

it can be shown

(|ũ(0)|+LR₁+2L∥qₜ∥_{∞})²≤2(∥ũ(0)|+LR₁)²+8L²∥qₜ∥_{∞}² (39)

And since

$$𝔼 [ {( \tilde{u} ( {d}_{t} ) - \tilde{u} ( 0 ) )}^{2} \vert {ℱ}_{t} ] \leq 𝔼 [ L \cdot {d}_{t}^{2} ] \qquad ( 40 )$$

$$= 𝔼 [ L \cdot {( {r}_{t} + γ \cdot {max}_{a} {q}_{t} ( {s}^{′} , a ) - {q}_{t} ( s , a ) )}^{2} ] \qquad ( 41 )$$

$$= 𝔼 [ L \cdot ( {r}_{t}^{2} + 2 {r}_{t} \cdot ( γ \cdot {max}_{a} {q}_{t} ( {s}^{′} , a ) - {q}_{t} ( s , a ) + {( γ \cdot {max}_{a} {q}_{t} {q}_{t} ( {s}^{′} , a ) - {q}_{t} ( s , a ) )}^{2} ) ] \qquad ( 42 )$$

$$= L {R}_{2} + 2 L {R}_{1} ( 1 - γ ) \cdot {‖ {q}_{t} ‖}_{∞} + {L ( 1 - γ )}^{2} \cdot {‖ {q}_{t} ‖}_{∞}^{2} \qquad ( 43 )$$

where R₂ is the upper bound for [symbol] [rₜ²] due to Assumption A.2 ( [symbol] [rₜ²]≤4σ²·Γ(1) [10]).

Note that here ũ(0)=0, therefore:

α² [symbol] [(ũ(dₜ))²| [symbol] ₜ]≤α²·(LR₂+2LR₁(1−γ)·∥qₜ∥_{∞}+L(1−γ)²·∥qₜ∥_{∞}²) (44)

hence,

[symbol]

[wₜ²(s,a)| [symbol] ₜ]≤2α²·(LR₂+2LR₁(1−γ)·∥qₜ∥_{∞}+L(1−γ)²·∥qₜ∥_{∞}² (45)

if ∥qₜ∥_{∞}≤1, then

[symbol]

[wₜ²(s,a)| [symbol] ₜ]≤2α²·(LR₂+2LR₁(1−γ)+L(1−γ)·∥qₜ∥_{∞}²) (46)

if ∥qₜ∥_{∞}>1, then

[symbol]

[wₜ²(s,a)| [symbol] ₜ]≤2α²·(LR₂+(2LR₁(1−γ)+L(1−γ)²)·∥qₜ∥_{∞}²) (47)

It has been shown that qₜ satisfy all of the requirements in Proposition 1, so qₜ→q* with probability 1.

### Nash-Q Learning Algorithm

This sub-section describes the Nash-Q Learning Algorithm [16] and its convergence guarantees. Assumption B.3 below will also be used in proof of RAM-Q. FIG. 9 shows an example Nash Q-learning algorithm (Algorithm 6) for Agent A: for ∀(s, a_{A}, a_{B}), the training system initializes Q_{A}¹(s, a_{A}, a_{B})=0; Q_{A}²(s, a_{A}, a_{B})=0; N_{A}(s, a_{A}, a_{B})=0.

From t=1 to T, for each value of t: at state sₜ, the training system compute π_{A}¹(sₜ), which is a mixed strategy Nash equilibrium solution of the bimatrix game (Q_{A}¹(sₜ), Q_{A}²(sₜ)). The system can select an action at aₜ^{A} based on π_{A}¹(sₜ) according to ϵ-greedy strategy, then observe and compute rₜ^{A},rₜ^{B}, aₜ^{B} and sₜ₊₁. At state sₜ₊₁, the training system computes π_{A}¹(sₜ₊₁), π_{A}²(sₜ₊₁), which are mixed strategies Nash equilibrium solution of the bimatrix game (Q_{A}¹(sₜ₊₁), Q_{A}²(sₜ₊₁)). The training system then updates N_{A}(sₜ,aₜ^{A}, aₜ^{B})=N_{A}(sₜ,aₜ^{A}, aₜ^{B})+1 and sets learning rate

$${α}_{t}^{A} = \frac{1}{{N}_{A} ( {s}_{t} , {a}_{t}^{A} , {a}_{t}^{B} )} .$$

The system can update Q_{A}¹, Q_{A}² such that

Q_{A}¹(sₜ,aₜ^{A},aₜ^{B})=(1−αₜ^{A})·Q_{A}¹(sₜ,aₜ^{A},aₜ^{B})+αₜ^{A}·[rₜ^{A}+γ·π_{A}¹(sₜ₊₁)Q_{A}¹(sₜ₊₁)π_{A}²(sₜ₊₁)]

Q_{A}²(sₜ,aₜ^{A},aₜ^{B})=(1−αₜ^{A})·Q_{A}²(sₜ,aₜ^{A},aₜ^{B})+αₜ^{A}·[rₜ^{B}+γ·π_{A}¹(sₜ₊₁)Q_{A}²(sₜ₊₁)π_{A}²(sₜ₊₁)]

Assumption B.3 [16] A Nash equilibrium (π¹(s), π²(s)) for any bimatrix game (Q¹(s), Q²(s)) during the training process satisfies one of the following properties:

1. The Nash equilibrium is global optimal.

π¹(s)Q^{k}(s)π²(s)≥\hat{π}¹(s)Q^{k}(s)\hat{π}²(s) ∀\hat{π}¹(s),\hat{π}²(s), and k=1,2 (48)

2. If the Nash equilibrium is not a global optimal, then an agent receives a higher payoff when the other agent deviates from the Nash equilibrium strategy.

π¹(s)Q¹(s)π²(s)≤π¹(s)Q¹(s)\hat{π}²(s) ∀\hat{π}²(s) (49)

π¹(s)Q^{k}(s)π²(s)≥\hat{π}¹(s)Q^{k}(s)\hat{π}²(s) ∀\hat{π}¹(s) (50)

Theorem 5 (Theorem 4, [16]) under Assumption B.3, the coupled sequences Q_{A}¹, Q_{A}² updated by Algorithm 6, converge to the Nash equilibrium Q values (Q_{*}¹,Q_{*}²), with Q_{*}^{k} (k=1,2) defined as

Q_{*}¹(s,a^{A},a^{B})=r^{A}(s,a^{A},a^{B})+γ· [symbol] [J^{A}(s′,π_{*}^{A},π_{*}^{B})] (51)

Q_{*}²(s,a^{A},a^{B})=r^{B}(s,a^{A},a^{B})+γ· [symbol] [J^{B}(s′,π_{*}^{A},π_{*}^{B})] (52)

where (π_{*}^{A},π_{*}^{B}) is a Nash equilibrium solution for this stochastic game (J^{A},J^{B}) and

J^{A}(s′,π_{*}^{A},π_{*}^{B})=Σₜ₌₀^{∞}γ^{t} [symbol] [rₜ^{A}|π_{*}^{A},π_{*}^{B},s₀=s′] (53)

J^{B}(s′,π_{*}^{A},π_{*}^{B})=Σₜ₌₀^{∞}γ^{t} [symbol] [rₜ^{B}|π_{*}^{A},π_{*}^{B},s₀=s′] (54)

### Proof of Theorem 2

Poisson masks M˜Poisson(1) provides parallel learning since

$$Binomial ( T , \frac{1}{T} ) \to Poisson ( 1 )$$

as T→∞, so each Q table Qⁱ is trained in parallel. The proof of convergence of Qⁱ for all i ∈ {1, . . . , k} is shown in the Proof of Theorem 1 above. Hence

$$\frac{1}{k} {\sum }_{i = 1}^{k} {Q}^{i} \to {Q}^{*} w . p \text{.1} .$$

### Proof of Convergence of RAM-Q

In this section, the convergence of Algorithm 3 (RAM-Q) is proven under Assumption B.3. The convergence proof is based on the following lemma.

Lemma D.3 (Conditional Averaging Lemma [30]) Assume the learning rate αₜ satisfies Proposition 1(a). Then, the process Qₜ₊₁(i)=(1−αₜ(i))Qₜ(i)+αₜwₜ(i) converges to [symbol] [wₜ(i)|hₜ,αₜ], where hₜ is the history at time t.

The proof of convergence of Q^{P} is shown as an example, and the proof of convergence of Q^{A} is the same. First, the the update rule Eq. (11) is reformulated as:

$${Q}^{P} ( {s}_{t} , {a}_{t}^{P} , {a}_{t}^{A} ) = ( 1 - \frac{{α}_{t}}{α} ) \cdot {Q}^{P} ( {s}_{t} , {a}_{t}^{P} , {a}_{t}^{A} ) + \frac{{α}_{t}}{α} . [ α \cdot {u}^{P} ( {r}_{t}^{P} + γ \cdot {π}^{P} ( {s}_{t + 1} ) {Q}^{P} ( {s}_{t + 1} ) {π}^{A} ( {s}_{t + 1} ) - {Q}^{P} ( {s}_{t} , {a}_{t}^{P} , {a}_{t}^{A} ) ) - α \cdot {x}_{0} + \qquad ( 55 )$$

$${Q}^{P} ( {s}_{t} , {a}_{t}^{P} , {a}_{t}^{A} ) ] \qquad ( 56 )$$

set

(H^{P}Q^{P})(sₜ,aₜ^{P},aₜ^{A})=α·u^{P}(rₜ^{P}+γ·π^{P}(sₜ₊₁)Q^{P}(sₜ₊₁)π^{A}(sₜ₊₁)−Q^{P}(sₜ,aₜ^{P},aₜ^{A}))−α·x₀+Q^{P}(sₜ,aₜ^{P},aₜ^{A}) (57)

and H^{A}Q^{A} is defined symmetrically as

(H^{A}Q^{A})(sₜ,aₜ^{P},aₜ^{A})=α·u^{A}(rₜ^{A}+γ·π^{P}(sₜ₊₁)Q^{A}(sₜ₊₁)π^{A}(sₜ₊₁)−Q^{A}(sₜ,aₜ^{P},aₜ^{A}))−α·x₁+Q^{A}(sₜ,aₜ^{P},aₜ^{A}) (58)

It's shown in [16] that the operator (Mₜ^{P}, Mₜ^{A}) is a γ-contraction mapping where (Mₜ^{P}, Mₜ^{A}) is defined as

Mₜ^{P}Q^{P}(s)=rₜ^{P}+γ·π^{P}(s)Q^{P}(s)π^{A}(s) (59)

Mₜ^{A}Q^{A}(s)=rₜ^{A}+γ·π^{P}(s)Q^{A}(s)π^{A}(s) (60)

Next, it is shown that (H^{P}, H^{A}) is a contraction under sup-norm (under Assumption A.1).

$${H}^{P} {Q}^{P} - {H}^{P} {\hat{Q}}^{P} = α \cdot [ {ξ}_{{Q}^{P} , {\hat{Q}}^{P}}^{P} \cdot ( {M}^{P} {Q}^{P} - {M}^{P} {\hat{Q}}^{P} - ( {Q}^{P} - {\hat{Q}}^{P} ) ) ] + ( {Q}^{P} - {\hat{Q}}^{P} ) \qquad ( 61 )$$

$$\leq α \cdot [ {ξ}_{{Q}^{P} , {\hat{Q}}^{P}}^{P} \cdot ( γ - 1 ) {‖ {Q}^{P} - {\hat{Q}}^{P} ‖}_{∞} ] + {‖ {Q}^{P} - {\hat{Q}}^{P} ‖}_{∞} \qquad ( 62 )$$

$$\leq ( 1 - α ∈ ( 1 - γ ) ) \cdot {‖ {Q}^{P} - {\hat{Q}}^{P} ‖}_{∞} \qquad ( 63 )$$

Similarly, H^{A}Q^{A}−H^{A}\hat{Q}^{A}≤(1−αϵ(1−γ))·∥Q^{A}−\hat{Q}^{A}∥_{∞}.

Hence (H^{P}, H^{A}) is a (1−αϵ(1−γ))-contraction under sup-norm. By Lemma D.3, the update rules Eqs. (11) and (12) respectively converges to

Q^{P}(sₜ,aₜ^{P},aₜ^{A})→ [symbol] [α·u^{P}(rₜ^{P}+γ·π^{P}(sₜ₊₁)Q^{P}(sₜ₊₁)π^{A}(sₜ₊₁)−Q^{P}(sₜ,aₜ^{P},aₜ^{A}))−α·x₀Q^{P}(sₜ,aₜ^{P},aₜ^{A})] (64)

Q^{A}(sₜ,aₜ^{P},aₜ^{A})→ [symbol] [α·u^{A}(rₜ^{A}+γ·π^{P}(sₜ₊₁)Q^{A}(sₜ₊₁)π^{A}(sₜ₊₁)−Q^{A}(sₜ,aₜ^{P},aₜ^{A}))−α·x₀Q^{A}(sₜ,aₜ^{P},aₜ^{A})] (64)

i.e., Eqs. (11) and (12) respectively converges to Q*_{P}, Q*^{A}, where Q*_{P}, Q*^{A} are the solution to the Bellman equations

[symbol]

_{s,a}_{^{P}}_{,a}_{^{A}}[u^{P}(r^{P}(s,a^{P},a^{A})+γ·π^{P}*(s′)Q_{P}*(s′)π^{A}*(s′)−Q_{P}*(s,a^{P},a^{A}))]=x₀ (66)

[symbol]

_{s,a}_{^{P}}_{,a}_{^{A}}[u^{A}(r^{A}(s,a^{P},a^{A})+γ·π^{P}*(s′)Q_{A}*(s′)π^{A}*(s′)−Q_{A}*(s,a^{P},a^{A}))]=x₁ (68)

where (π^{P}*,π^{A}*) is the Nash equilibrium solution to the bimatrix game (Q*_{P}, Q*_{A}).

Next it is shown that (π^{P}*,π^{A}*) is a Nash equilibrium solution for the game with equilibrium payoffs (\tilde{J}^{P} (s,π^{P}*,π^{A}*),\tilde{J}^{A}(s,π^{P}*,π^{A}*)). As in [28], for any X ∈ [symbol] , define [symbol] ^{P} (X|s, a^{P}, a^{A}): [symbol] × [symbol] × [symbol] × [symbol] → [symbol] be a mapping (for brevity, could be written as [symbol] _{s,a}_{^{P}}_{,a}_{^{A}} defined by

[symbol]

_{s,a}_{^{P}}_{,a}_{^{A}}(X)=sup{m∈ [symbol] | [symbol] _{s,a}_{^{P}}_{,a}_{^{A}}[u^{P}(X−m)]≥x₀} (68)

Similar to [28, 32], suppose (π^{P}, π^{A}) is a Nash equilibrium solution to the game (\tilde{J}^{P}(s, π^{P}, π^{A}), \tilde{J}^{A}(s, π^{P}, π^{A})) then the payoffs \tilde{J}^{P}(s, π^{P}, π^{A}), \tilde{J}^{A}(s, π^{P}, π^{A}) are the solution to the risk-sensitive Bellman equations

\tilde{J}^{P}(s,π^{P},π^{A})=π^{P}(s) [symbol] _{s,a}_{^{P}}_{,a}_{^{A}}^{P}(r^{P}(s,:,:)+γ·\tilde{J}^{P}(s′,π^{P},π^{A}))π^{A}(s)∀s∈ [symbol] (69)

\tilde{J}^{A}(s,π^{P},π^{A})=π^{P}(s) [symbol] _{s,a}_{^{P}}_{,a}_{^{A}}^{P}(r^{A}(s,:,:)+γ·\tilde{J}^{A}(s′,π^{P},π^{A}))π^{A}(s)∀s∈ [symbol] (70)

And the corresponding Q tables satisfies

Q_{P}(s,a^{P},a^{A})= [symbol] _{s,a}_{^{P}}_{,a}_{^{A}}^{P}(r^{P}(s,a^{P},a^{A})+γ\tilde{J}^{P}(s′,π^{P},π^{A})) (71)

Q_{A}(s,a^{P},a^{A})= [symbol] _{s,a}_{^{P}}_{,a}_{^{A}}^{P}(r^{A}(s,a^{P},a^{A})+γ\tilde{J}^{A}(s′,π^{P},π^{A})) (72)

Note that [symbol] _{s,a}_{^{P}}_{,a}_{^{A}}^{P} is monotonic one-to-one mapping, so as shown in Theorem 4.6.5 in [13], (π^{P}, π^{A}) are the Nash equilibrium solution to the bimatrix game (Q_{P}, Q_{A}). Then if Q_{P}=Q_{P}*; and Q_{A}=Q_{A}* (i.e., Q_{P} and Q_{A} are the solution to Eq.(66)), then the Nash solution of the bimatrix game (Q_{P}*, Q^{A}*) returned by Algorithm 3 (RAM-Q) will be the Nash solution for the game (\tilde{J}^{P}, \tilde{J}^{A}).

[28] showed that Eq. (71) is equivalent to

[symbol]

_{s,a}_{^{P}}_{,a}_{^{A}}[u^{P}(r^{P}(s,a^{P},a^{A})+γ\tilde{J}^{P}(s′,π^{P},π^{A})−Q_{P}(s,a^{P},a^{A}))]=x₀ (73)

[symbol]

_{s,a}_{^{P}}_{,a}_{^{A}}[u^{A}(r^{A}(s,a^{P},a^{A})+γ\tilde{J}^{A}(s′,π^{P},π^{A})−Q_{A}(s,a^{P},a^{A}))]=x₁ (74)

### Plugging Eq. (69),

[symbol] _{s,a}_{^{P}}_{,a}_{^{A}}[u^{P}(r^{P}(s,a^{P},a^{A})+γ·π^{P}Q_{P}(s′)π^{A}−Q_{P}(s,a^{P},a^{A}))]=x₀ (75)

[symbol]

_{s,a}_{^{P}}_{,a}_{^{A}}[u^{A}(r^{A}(s,a^{P},a^{A})+γ·π^{P}Q_{A}(s′)π^{A}−Q_{A}(s,a^{P},a^{A}))]=x₁ (76)

which is exactly Eq. (66).

It has been shown that under Assumption B.3, Eq. (69) and Eq. (66) are equivalent. Hence Algorithm 3 (RAM-Q) converges to (Q_{P}*, Q_{A}*) s.t. the Nash equilibrium solution (π^{P}*, π^{A}*) for the bimatrix game (Q_{P}*, Q_{A}*) is the Nash equilibrium solution to the game and the equilibrium payoffs are \tilde{J}^{P} (s, π^{P}*, π^{A}*); \tilde{J}^{A} (s, π^{P}*, π^{A}*).

### RA3-Q

Previously, a short version of RA3-Q is presented in Algorithm 4 (e.g., FIG. 6), a detailed version is presented in Algorithm 7. FIGS. 10A and 10B show an example risk-averse adversarial Q-learning algorithm (RA3-Q, Algorithm 7). The input data may include, training steps T; exploration rate E; number of models k; risk control parameters λ_{P},λ_{A}; utility function parameters β^{P}<0; β^{A}>0.

The training system first initializes Q_{P}ⁱ(s, a_{P}, a_{A})=0; Q_{A}ⁱ(s, a_{P}, a_{A})=0 for ∀i=1, . . . , k and (s, a_{A}, a_{P}); N=0 ∈ [symbol] The training system then randomly samples action by choosing head integers H_{P}, H_{A} ∈ {1, . . . , k}.

From t=1 to T, for each value of t (“while in the t loop”): the training system sets Q_{P}=Q_{P}^{H}^{_{P}} and computes \hat{Q}_{P} by:

$${\hat{Q}}_{P} ( s , {a}_{P} , {a}_{A} ) = {Q}_{P} ( s , {a}_{P} , {a}_{A} ) - {λ}_{P} \cdot \frac{{\sum }_{i = 1}^{k} {( {Q}_{P}^{i} ( s , {a}_{P} , {a}_{A} ) - {\overline{Q}}_{P} ( s , {a}_{P} , {a}_{A} ) )}^{2}}{k - 1} {λ}_{P} > 0 where {\overline{Q}}_{P} ( s , {a}_{P} , {a}_{A} ) = \frac{1}{k} {\sum }_{i = 1}^{k} {Q}_{P}^{i} ( s , {a}_{P} , {a}_{A} ) ; \qquad ( 77 )$$

the training system sets Q_{A}=Q_{A}^{H}^{_{A}} and computes \hat{Q}_{A} by

$${\hat{Q}}_{A} ( s , {a}_{P} , {a}_{A} ) = {Q}_{A} ( s , {a}_{P} , {a}_{A} ) + {λ}_{A} \cdot \frac{{\sum }_{i = 1}^{k} {( {Q}_{A}^{i} ( s , {a}_{P} , {a}_{A} ) - {\overline{Q}}_{A} ( s , {a}_{P} , {a}_{A} ) )}^{2}}{k - 1} {λ}_{A} > 0 where {\overline{Q}}_{A} ( s , {a}_{P} , {a}_{A} ) = \frac{1}{k} {\sum }_{i = 1}^{k} {Q}_{A}^{i} ( s , {a}_{P} , {a}_{A} ) . \qquad ( 78 )$$

The optimal actions (a′_{P}, a′_{A}) are defined as

$${\hat{Q}}_{P} ( {s}_{t} , {a}_{p}^{′} , {a}_{A}^{0} ) = {max}_{{a}_{P} , , {a}_{A}} {\hat{Q}}_{P} ( {s}_{t} , {a}_{P} , {a}_{A} ) for some {a}_{A}^{0} \qquad ( 79 )$$

$${\hat{Q}}_{A} ( {s}_{t} , {a}_{p}^{0} , {a}_{A}^{′} ) = {max}_{{a}_{P} , {a}_{A}} {\hat{Q}}_{A} ( {s}_{t} , {a}_{P} , {a}_{A} ) for some {a}_{P}^{0} \qquad ( 80 )$$

While in the t loop, the training system selects actions a_{P}, a_{A} according to \hat{Q}_{P}, \hat{Q}_{A} by applying ϵ-greedy strategy. Two agents respectively execute actions a_{P}, a_{A} and observe (sₜ,a_{P}, a_{A}, rₜ^{A}, rₜ^{P}, sₜ₊₁)

While in the t loop, the training system generates mask M ∈ [symbol] ^{k}˜Poisson(1) and updates

$$α ( {s}_{t} , {a}_{P ′} {a}_{A} ) = \frac{1}{N ( {s}_{t} {a}_{P} , {a}_{A} )}$$

and N(sₜ,a_{P},a_{A})=N(sₜ,a_{P}, a_{A})+1.

While in the t loop, from i=1, . . . , k, for each value of i (“while in the i loop”): if and when Mᵢ=1, the training system updates Q_{P}ⁱ by

$${Q}_{P}^{i} ( {s}_{t} , {a}_{P} , {a}_{A} ) = {Q}_{P}^{i} ( {s}_{t} , {a}_{P ′} {a}_{A} ) + α ( {s}_{t} , {a}_{P} , {a}_{A} ) \cdot [ {u}^{P} ( {r}_{t}^{P} + γ \cdot {max}_{{a}_{P} , {a}_{A}} {Q}_{P}^{i} ( {s}_{t + 1} , {a}_{P} , {a}_{A} ) - {Q}_{P}^{i} ( {s}_{t} , {a}_{P} , {a}_{A} ) ) - {x}_{0} ] \qquad ( 81 )$$

where u^{P} is a monotonically increasing concave utility function, e.g., u^{P}(x)=−e^{β}^{^{P}}^{x} where β^{P}<0; and x₀=−1.

While in the t loop, from i=1, . . . , k, for each value of i (“while in the i loop”):”): if and when Mᵢ=1, the training system updates Q_{A}ⁱ by:

$${Q}_{A}^{i} ( {s}_{t} , {a}_{P} , {a}_{A} ) = {Q}_{A}^{i} ( {s}_{t} , {a}_{P ′} {a}_{A} ) + α ( {s}_{t} , {a}_{P} , {a}_{A} ) \cdot [ {u}^{A} ( {r}_{t}^{A} + γ \cdot {max}_{{a}_{P} , {a}_{A}} {Q}_{A}^{i} ( {s}_{t + 1} , {a}_{P} , {a}_{A} ) - {Q}_{A}^{i} ( {s}_{t} , {a}_{P} , {a}_{A} ) ) - {x}_{1} ] \qquad ( 82 )$$

where u^{A} is a monotonically increasing convex utility function, e.g., u(x)=e^{β}^{^{A}}^{·x} where β^{A}>0; x₁=1.

Once outside of the i loop, the training system updates H_{P} and H_{A} by randomly sampling integers from 1 to k.

Once outside of the t loop, the training system returns

$$\frac{1}{k} {\sum }_{i = 1}^{k} {Q}_{P}^{i} ; \frac{1}{k} {\sum }_{i = 1}^{k} {Q}_{A}^{i} .$$

In this section, convergence issues of RA3-Q are discussed. First a simplified setting is shown where if the adversary's policy is a fixed policy π₀^{A}, the update rule for protagonist agent Eq. (81) converges to the optimal of J^{P}(s, :, π₀^{A}). Similarly, if the protagonist's policy is a fixed policy π₀^{P}, the update rule for adversary agent Eq. (82) converges to the optimal of J^{A}(s, π₀^{P}, :).

Poisson masks M˜Poisson(1) provides parallel learning since

$$Binomial ( T , \frac{1}{T} ) \to Poisson ( 1 )$$

as T→∞, so each Q table of protagonist/adversary, Q_{P}ⁱ, Q_{A}ⁱ, are trained in parallel respectively.

First, the proof for the convergence of the iterative procedure is shown. The protagonist agent is used as an example, and the proof for adversary is similar.

Fix the policy for adversary, then according to Proposition 3.1 in [28], for any random variable X, the following statements are equivalent:

$$\frac{1}{{β}^{P}} log {𝔼}_{μ} [ exp ( {β}^{P} \cdot X ) ] = {m}^{*} \qquad ( i )$$

$${𝔼}_{μ} [ {u}^{P} ( X - {m}^{*} ) ] = {x}_{0} \qquad ( ii )$$

The above proposition is used in the following context to show that the convergent point is the optimal of the objective function \tilde{J}^{P}(s, :, π₀^{A}).

Compared to RAQL (Algorithm 5), RA3-Q uses multi-agent extension of MDP, where the transition function is [symbol] : [symbol] × [symbol] × [symbol] → [symbol] . The update rule Eq. (81) can be reformulated by letting:

$${q}_{t + 1}^{P} ( s , {a}_{P} , {a}_{A} ) = ( 1 - \frac{{α}_{t} ( s , {a}_{P} , {a}_{A} )}{α} ) {q}_{t}^{P} ( s , {a}_{P} , {a}_{A} ) + \frac{{α}_{t} ( s , {a}_{P} , {a}_{A} )}{α} \cdot [ α \cdot u ( {d}_{t} ) - {x}_{0} + {q}_{t}^{P} ( s , {a}_{P} , {a}_{A} ) ] \qquad ( 83 )$$

$$\begin{matrix}where {d}_{t} : = {r}_{t}^{P} + γ \cdot {max}_{{a}_{P} , {a}_{A}} {q}_{t}^{P} ( {s}^{′} , {a}_{P} , {a}_{A} ) - {q}_{t}^{P} ( s , {a}_{P} , {a}_{A} ) & {x}_{0} = - 1 & α ∈ & ( 0 , min ( {L}^{- 1} , 1 ) ]\end{matrix} \\ and set \qquad ( 84 )$$

$$( {H}^{P} {q}_{t}^{P} ) ( s , {a}_{P} , {a}_{A} ) = α \cdot {𝔼}_{s , {a}_{P} , {a}_{A}} [ \tilde{u} ( {r}_{t}^{P} + γ \cdot {max}_{{a}_{P} , {a}_{A}} {q}_{t}^{P} ( {s}^{′} , {a}_{P} , {a}_{A} ) - {q}_{t}^{P} ( s , {a}_{P} , {a}_{A} ) ) + {q}_{t}^{P} ( s , {a}_{P ′} {a}_{A} ) \qquad ( 85 )$$

$${w}_{t} ( s , {a}_{P} , {a}_{A} ) = α \cdot \tilde{u} ( {d}_{t} ) - α \cdot {𝔼}_{s , {a}_{P} , {a}_{A}} [ \tilde{u} ( {r}_{r}^{P} + γ \cdot {max}_{{a}_{P} , {a}_{A}} {q}_{t}^{P} ( {s}^{′} , {a}_{P} , {a}_{A} ) - {q}_{t}^{P} ( s , {a}_{P} , {a}_{A} ) ) \qquad ( 86 )$$

$$ũ ( x ) = u ( x ) - {x}_{0} \qquad ( 87 )$$

Next it is shown that H^{P} is a (1−α(1−γ)ϵ)-contractor under Assumption A.1: for any two q tables q, q′, define

$${v}^{P} ( s ) : = {max}_{{a}_{P} , {a}_{A}} q ( s , {a}_{P} , {a}_{A} ) and {v}^{{P}^{′}} ( s ) := {max}_{{a}_{P ,} {a}_{A}} {q}^{′} ( s , {a}_{P} , {a}_{A} ) .$$

### Thus,

$$\vert {v}^{P} ( s ) - {v}^{{P}^{′}} ( s ) \vert \leq {max}_{s , {a}_{P} , {a}_{A}} \vert q ( s , {a}_{P} , {a}_{A} ) - {q}^{′} ( s , {a}_{P} , {a}_{A} ) \vert = {‖ q - {q}^{′} ‖}_{∞} \qquad ( 88 )$$

By Assumption A.1 and monotonicity of ũ, for given x, y ∈ [symbol] , there exists ξ_{(x,y)} ∈ [ϵ, L] such that

$$\tilde{u} ( x ) - \tilde{u} ( y ) = {ξ}_{( x , y )} \cdot ( x - y ) , \\ then \\ ( {H}^{P} q ) ( s , {a}_{P} , {a}_{A} ) - ( {H}^{P} {q}^{′} ) ( s , {a}_{P} , {a}_{A} ) \qquad ( 89 )$$

$$= {\sum }_{{s}^{′}} 𝒫 [ {s}^{′} \vert s , {a}_{P} , {a}_{A} ] \cdot \{ {αξ}_{( s , {a}_{P} , {a}_{A} , {s}^{′} , q , {q}^{′} )} \cdot [ γ \cdot {v}^{P} ( {s}^{′} ) - γ \cdot {v}^{{P}^{′}} ( {s}^{′} ) - q ( s , {a}_{P} , {a}_{A} ) + {q}^{′} ( s , {a}_{P} , {a}_{A} ) ] + ( q ( s , {a}_{P} , {a}_{A} ) - {q}^{′} ( s , {a}_{P} , {a}_{A} ) ) \} \qquad ( 90 )$$

$$\leq ( 1 - α ( 1 - γ ) {\sum }_{{s}^{′}} 𝒫 [ {s}^{′} \vert s , {a}_{P} , {a}_{A} ] \cdot {ξ}_{( s , {a}_{P} , {a}_{A} , {s}^{′} , q , {q}^{′} )} ) {‖ q - {q}^{′} ‖}_{∞} \qquad ( 91 )$$

$$\leq ( 1 - α ( 1 - γ ) ∈ ) {‖ q - {q}^{′} ‖}_{∞} \qquad ( 92 )$$

Hence H^{P} is a contractor.

By Eq. (86), [symbol] [wₜ(s, a_{P}, a_{A})| [symbol] ₜ]=0. Hence it remains to prove b(ii) in Proposition 1.

[symbol]

[wₜ²(s,a_{P},a_{A})| [symbol] ₜ]=α²· [symbol] [(ũ(dₜ))²| [symbol] ₜ]−α²( [symbol] [ũ(dₜ)| [symbol] ₜ])²≤α²· [symbol] [(ũ(dₜ))²|Fₜ] (93)

Following from the same procedures as proof for Theorom 1, condition b(ii) of Proposition 1 also holds in this case. As the learning rate satisfies condition (a), by Proposition 1, q→q*, where q* is the solution to the Bellman equation

$$\begin{matrix}{𝔼}_{s , {a}_{P} , {a}_{A}} [ {u}^{P} ( {r}_{t}^{P} + γ \cdot {max}_{{a}_{P} , {a}_{A}} q ( {s}^{′} , {a}_{P} , {a}_{A} ) - q ( s , {a}_{P} , {a}_{A} ) ) ] = {x}_{0} & {π}_{0}^{A} is fixed\end{matrix} \qquad ( 94 )$$

for ∀(s, a_{P}, a_{A}), where s′ is sampled from [symbol] [⋅|s, a_{P}, a_{A}].

Similarly, it can be shown that for a fixed policy for protagonist agent, the update rule Eq. (82) will guarantee that q_{P}→q_{P}*, where q_{P}* is the solution to the Bellman equation

$$\begin{matrix}{𝔼}_{s , {a}_{P} , {a}_{A}} [ {u}^{A} ( {r}_{t}^{A} + γ \cdot {max}_{{a}_{P} , {a}_{A}} {q}_{P} ( {s}^{′} , {a}_{P} , {a}_{A} ) - {q}_{P} ( s , {a}_{P} , {a}_{A} ) ) ] = {x}_{1} & {π}_{0}^{P} is fixed\end{matrix} \qquad ( 95 )$$

for ∀(s, a_{P}, a_{A}), where s′ is sampled from [symbol] [⋅|s, a_{P}, a_{A}].

This does not imply a convergence guarantee of RA3-Q because of the protagonist/adversary's policy is fixed assumption. Only if one of the agents (e.g., the protagonist) stops learning (and its policy becomes fixed) at some point, then the other agent (adversary) will also converge. Note that in the general multi-agent learning case this is a challenge, and it is often hard to a balance between theoretical algorithms (with convergence guarantees) and practical algorithms (loosing guarantees but with good empirical results), as shown in the experimental results above.

### Meta-Game Payoff Examples and EGT Plots

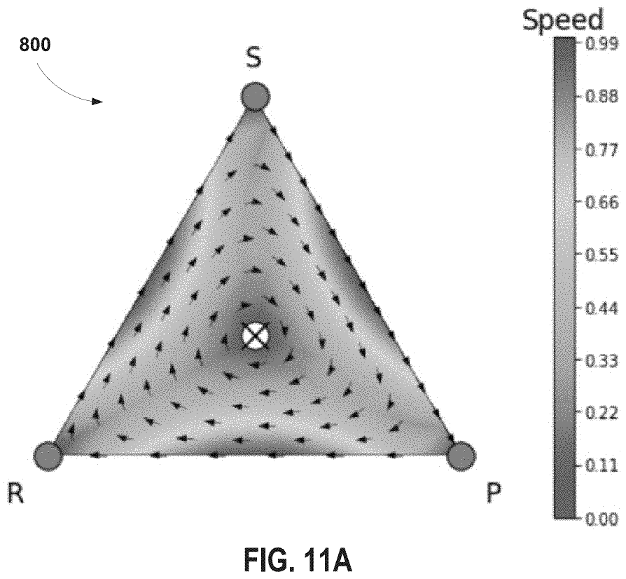

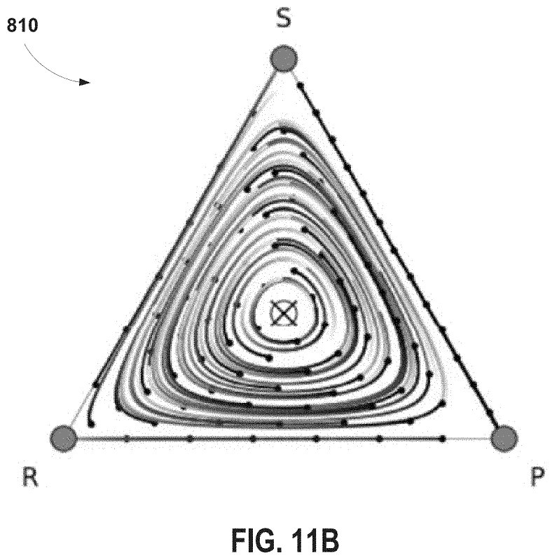

Table 4 shows a payoff table of rock-paper-scissors game; its corresponding directional field 800 is shown in FIG. 11A, and its trajectory plot 810 is as shown in FIG. 11B. It can be observed from FIGS. 11A and 11B that the equilibrium of Rock-Paper-Scissors is the centroid of the strategies simplex.

TABLE 4
Payoff Table of Rock-Paper-Scissors

| N_{Rock} | N_{Paper} | N_{Scissors} | R_{Rock} | R_{Paper} | R_{Scissors} |
|---|---|---|---|---|---|
| 2 | 0 | 0 | 0 | 0 | 0 |
| 1 | 1 | 0 | −1 | 1 | 0 |
| 0 | 2 | 0 | 0 | 0 | 0 |
| 1 | 0 | 1 | 1 | 0 | −1 |
| 0 | 0 | 2 | 0 | 0 | 0 |
| 0 | 1 | 1 | 0 | −1 | 1 |

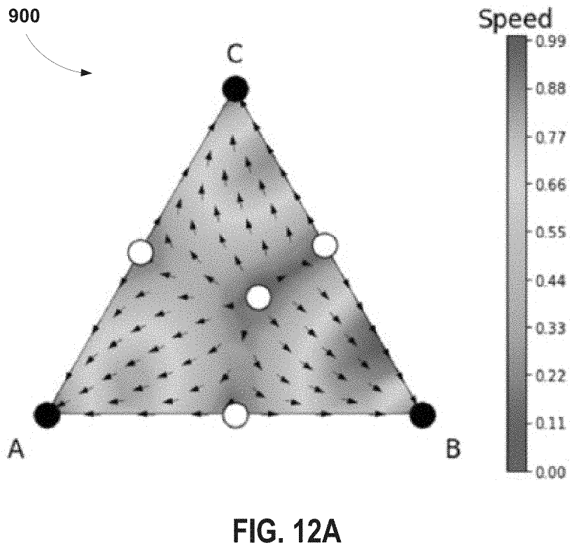

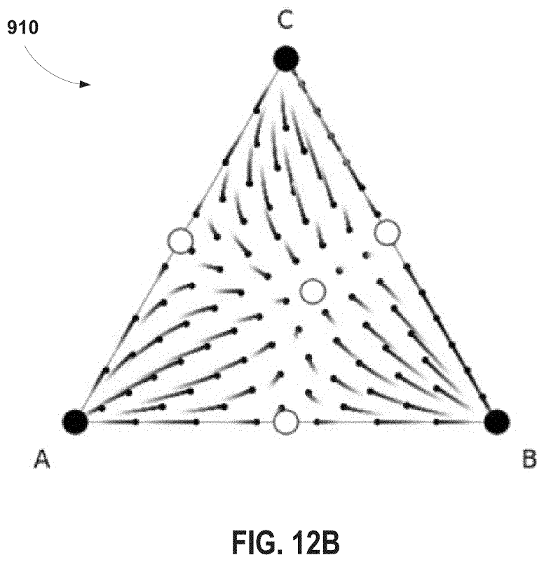

Another example of a two-player meta-game payoff table of three strategies is in Table 5 with its corresponding directional field 900 as shown in FIG. 12A and its trajectory plot 910 in FIG. 12B, where the white circles denote unstable equilibria (saddle points) and black solid circles denote globally stable equilibriums.

TABLE 5
An example of a meta game payoff table of 2 players, 3 strategies.

| Nᵢ₁ | Nᵢ₂ | Nᵢ₃ | Rᵢ₁ | Rᵢ₂ | Rᵢ₃ |
|---|---|---|---|---|---|
| 2 | 0 | 0 | 0.5 | 0 | 0 |
| 1 | 1 | 0 | 0.3 | 0.7 | 0 |
| 0 | 2 | 0 | 0 | 0.9 | 0 |
| 1 | 0 | 1 | 0.35 | 0 | 0.45 |
| 0 | 0 | 2 | 0 | 0 | 0.6 |
| 0 | 1 | 1 | 0 | 0.66 | 0.38 |

### Proof of Theorem 4

Theorem 6. For a Normal Form Game with p players, and each player i chooses a strategy πⁱ from a set of strategies Sⁱ={π₁ⁱ, . . . , πₖⁱ}, and receives a risk averse payoff hⁱ(π¹, . . . , π^{P}): S¹× . . . ×S^{P}→ [symbol] satisfying Assumption G.4. If x is a Nash Equilibrium for the game ĥⁱ (π¹, . . . , π^{P}), then it is a 2ϵ-Nash equilibrium for the game hⁱ(π¹, . . . , π^{P}) with probability 1-δ if the game is played n times, where

$$n \geq max \{ - \frac{8 {R}^{2}}{{∈}^{2}} log [ \frac{1}{4} ( 1 - {( 1 - δ )}^{\frac{1}{\vert {s}^{1} \vert \times … \times \vert {s}^{p} \vert \times p}} ) ] , \frac{64 {β}^{2} {ω}^{2} \cdot Γ ( 2 )}{{∈}^{2} [ 1 - {( 1 - δ )}^{\frac{1}{\vert {s}^{1} \vert {\times }_{…} \times \vert {s}^{p} \vert \times p}} ]} \} \qquad ( 96 )$$

Assumption G.4 The stochastic return h (for each player and each strategy) for each simulation has a sub-Gaussian tail. i,e, there exists ω>0 s.t.

$$\begin{matrix}𝔼 [ exp ( c \cdot ( h - 𝔼 [ h ] ) ) ] \leq exp ( \frac{{ω}^{2} {c}^{2}}{2} ) & ∀ c ∈ ℝ\end{matrix} and R > 0 s . t . h ∈ [ - R , R ] . \qquad ( 97 )$$

Proof. Note that we have the following relation:

$${𝔼}_{π ∼ x} [ {h}^{i} ( π ) ] = {𝔼}_{π ∼ x} [ {\hat{h}}^{i} ( π ) ] + {𝔼}_{π - x} [ {h}^{i} ( π ) - {\hat{h}}^{i} ( π ) ] Then \qquad ( 98 )$$

$${𝔼}_{{π}^{- i} ∼ {x}^{- i}} [ {h}^{i} ( {π}^{i} , {π}^{- i} ) ] = {𝔼}_{{π}^{- i} ∼ {x}^{- i}} [ {\hat{h}}^{i} ( {π}^{i} , {π}^{- i} ) ] + {𝔼}_{{π}^{- i} ∼ {x}^{- i}} [ {h}^{i} ( {π}^{i} , {π}^{- i} ) - {\hat{h}}^{i} ( {π}^{i} , {π}^{- i} ) ] {max}_{{π}^{i}} {𝔼}_{{π}^{- i} ∼ {x}^{- i}} [ {h}^{i} ( {π}^{i} , {π}^{- i} ) ] \leq {max}_{{π}^{i}} {𝔼}_{{π}^{- i} ∼ {x}^{- i}} [ {\hat{h}}^{i} ( {π}^{i} , {π}^{- i} ) ] + {max}_{{π}^{i}} {𝔼}_{{π}^{- i} ∼ {x}^{- i}} [ {h}^{i} ( {π}^{i} , {π}^{- i} ) - \qquad ( 99 )$$

$${\hat{h}}^{i} ( {π}^{i} , {π}^{- i} ) ] \\ Hence , \qquad ( 100 )$$

$$\leq {max}_{{π}^{i}} {𝔼}_{{π}^{- i} ∼ {x}^{- i}} [ {h}^{i} ( {π}^{i} , {π}^{- i} ) ] - {𝔼}_{π ∼ x} [ {h}^{i} ( π ) ] \leq {\underbrace{{max}_{{π}^{i}} {𝔼}_{{π}^{- i} ∼ {x}^{- i}} [ {\hat{h}}^{i} ( {π}^{i} , {π}^{- i} ) ] - {𝔼}_{π ∼ x} [ {\hat{h}}^{i} ( π ) ]}}_{= 0 since x is a Nash Equilibrium for {\hat{h}}^{i}} + \qquad ( 101 )$$

$${\underbrace{{max}_{{π}^{i}} {𝔼}_{{π}^{- i} ∼ {x}^{- i}} [ {h}^{i} ( {π}^{i} , {π}^{- i} ) - {\hat{h}}^{i} ( {π}^{i} , {π}^{- i} ) ]}}_{\leq ∈} + {\underbrace{{E}_{π ∼ x} [ {\hat{h}}^{i} ( π ) - {h}^{i} ( π ) ]}}_{\leq ∈} \qquad ( 102 )$$

Hence, if the difference between |hⁱ(π)−ĥⁱ(π)| can be controlled uniformly over players and actions, then an equilibrium for the empirical game is almost an equilibrium for the game defined by the reward function. The question is how many samples n are needed to assess that a Nash equilibrium for ĥ is a 2ϵ-Nash equilibrium for h for a fixed confidence δ and a fixed ϵ.

In the following, in short, player i and the joint strategy π=(π¹, . . . , π^{P}) for p players are fixed, and denote hⁱ=hⁱ(π), ĥⁱ=ĥⁱ(π). By Hoeffding inequality,

$$ℙ [ \vert {\overline{R}}^{i} - 𝔼 [ {R}^{i} ] \vert \geq \frac{∈}{2} ] \leq 2 \cdot exp ( - \frac{{∈}^{2} n}{8 {R}^{2}} ) \qquad ( 103 )$$

Now, it remains to give a batch scenario for the unbiased estimator of variance penalty term. Denote

$${V}_{n}^{2} = \frac{1}{n - 1} {\sum }_{j = 1}^{n} {( {R}_{j}^{i} - {\overline{R}}^{i} )}^{2} ,$$

then [symbol] [Vₙ²]= [symbol] ar[Rⁱ]=δ², i.e., it's an unbiased estimator of the game variance. The variance of Vₙ² is computed first.

Let Zⱼⁱ=Rⱼⁱ− [symbol] [Rⁱ], then [symbol] [Zⁱ]=0 and Z₁ⁱ, . . . , Zₙⁱ are independent. Then

$${V}_{n}^{2} = 𝕍ar [ {R}^{i} ] = 𝕍ar [ {Z}^{i} ] . \qquad ( 104 )$$

$$𝕍ar [ {V}_{n}^{2} ] = 𝔼 [ {V}_{n}^{4} ] - {( 𝔼 [ {V}_{n}^{2} ] )}^{2} \qquad ( 105 )$$

$$= 𝔼 [ \frac{{{n}^{2} ( {\sum }_{j = 1}^{n} {( {Z}_{j}^{i} )}^{2} )}^{2} - 2 n ( {\sum }_{j = 1}^{n} {( {Z}_{j}^{i} )}^{2} ) {( {\sum }_{j = 1}^{n} {Z}_{j}^{i} )}^{2} + {𝔼 ( {\sum }_{j = 1}^{n} {Z}_{j}^{i} )}^{4}}{{{n}^{2} ( n - 1 )}^{2}} ] - {σ}^{4} \qquad ( 106 )$$

$$= \frac{[ {n}^{2} {𝔼 ( {\sum }_{j = 1}^{n} {( {Z}_{j}^{i} )}^{2} )}^{2} - 2 n 𝔼 ( {\sum }_{j = 1}^{n} {( {Z}_{j}^{i} )}^{2} ) {( {\sum }_{j = 1}^{n} {Z}_{j}^{i} )}^{2} + {𝔼 ( {\sum }_{j = 1}^{n} {Z}_{j}^{i} )}^{4} ]}{{{n}^{2} ( n - 1 )}^{2}} - {σ}^{4} \qquad ( 107 )$$

Since Z₁ⁱ, . . . , Zₙⁱ are independent, then for distinct j, k, m,

[symbol]

[ZⱼⁱZₖⁱ]=0; [symbol] [(Zⱼⁱ)³Zₖⁱ]=0; [symbol] [(Zⱼⁱ)²ZₖⁱZₘⁱ]=0. (108)

and denote

[symbol]

[(Zⱼⁱ)²(Zₖⁱ)²]=μ₂²=δ⁴; [symbol] [(Zⱼⁱ)⁴]=μ₄. (109)

then, with algebraic manipulations, Eq. (105) can be simplified as:

$$\begin{matrix}𝕍ar [ {V}_{n}^{2} ] & = \frac{\begin{matrix}{n}^{2} ( n {μ}_{4} + n ( n - 1 ) {μ}_{2}^{2} ) - \\ 2 n ( n {μ}_{4} + n ( n - 1 ) {μ}_{2}^{2} ) + n {μ}_{4} + 3 n ( n - 1 ) {μ}_{2}^{2}\end{matrix}}{{{n}^{2} ( n - 1 )}^{2}}\end{matrix} - {σ}^{4} \qquad ( 110 )$$

$$= \frac{( n - 1 ) {μ}_{4} + ( {n}^{2} - 2 n + 3 ) {σ}^{4}}{n ( n - 1 )} - {σ}^{4} \qquad ( 111 )$$

$$= \frac{{μ}_{4}}{n} - \frac{{σ}^{4} ( n - 3 )}{n ( n - 1 )} . \qquad ( 112 )$$

by Chebyshev's inequality,

$$ℙ [ \vert {V}_{n}^{2} - 𝕍ar [ {R}^{i} ] \vert \geq \frac{ϵ}{2 β} ] \leq \frac{𝕍ar [ {V}_{n}^{2} ]}{{( \frac{ϵ}{2 β} )}^{2}} \qquad ( 113 )$$

$$\leq \frac{4 {β}^{2} ( \frac{{μ}_{4}}{n} - \frac{{σ}^{4} ( n - 3 )}{n ( n - 1 )} )}{{ϵ}^{2}} \qquad ( 114 )$$

### by Assumption G.4,

μ₄≤16ω²·Γ(2) (115)

by triangle inequality,

$$ℙ [ \vert {h}^{i} - {\hat{h}}^{i} \vert \geq ϵ ] \leq ℙ [ \vert 𝔼 [ {R}^{i} ] - {\overline{R}}^{i} \vert + β \cdot \vert {V}_{n}^{2} - 𝕍ar [ {R}^{i} ] \vert \geq ϵ ] \qquad ( 116 )$$

$$\begin{matrix}\leq ℙ [ \vert 𝔼 [ {R}^{i} ] - {\overline{R}}^{i} \vert \geq \frac{ϵ}{2} or β \cdot \vert {V}_{n}^{2} - 𝕍ar [ {R}^{i} ] \vert \geq \frac{ϵ}{2} ] & ( 117 )\end{matrix}$$

$$\leq ℙ [ \vert 𝔼 [ {R}^{i} ] - {\overline{R}}^{i} \vert \geq \frac{ϵ}{2} ] + ℙ [ \vert {V}_{n}^{2} - 𝕍ar [ {R}^{i} ] \vert \geq \frac{ϵ}{2 β} ] \qquad ( 118 )$$

$$\leq 2 \cdot exp ( - \frac{{ϵ}^{2} n}{8 {R}^{2}} ) + \frac{4 {β}^{2} ( \frac{16 {ω}^{2} \cdot Γ ( 2 )}{n} - \frac{{σ}^{4} ( n - 3 )}{n ( n - 1 )} )}{{ϵ}^{2}} \qquad ( 119 )$$

$$\leq 2 \cdot exp ( - \frac{{ϵ}^{2} n}{8 {R}^{2}} ) + \frac{64 {β}^{2} {ω}^{2} \cdot Γ ( 2 )}{n {ϵ}^{2}} \qquad ( 120 )$$

$$= f ( n , ϵ ) . \qquad ( 121 )$$

Therefore, for per joint strategies π and per player i, the following bound exists:

$$ℙ [ {sup}_{π , i} \vert {h}^{i} ( π ) - {\hat{h}}^{i} ( π ) \vert < ϵ ] \geq {( 1 - f ( n , ϵ ) )}^{\vert {S}^{1} \vert \times … \times \vert {S}^{P} \vert \times p} \qquad ( 122 )$$

hence, for

$$n \geq max \{ - \frac{8 {R}^{2}}{{ϵ}^{2}} log [ \frac{1}{4} ( 1 - ( 1 - δ ) \frac{1}{\vert {S}^{1} \vert \times … \times \vert {S}^{p} \vert \times p} ) ] ; \frac{64 {β}^{2} {ω}^{2} \cdot Γ ( 2 )}{{ϵ}^{2} [ 1 - ( 1 - δ ) \frac{1}{\vert {S}^{1} \vert \times … \times \vert {S}^{p} \vert \times p} ]} \} \qquad ( 123 )$$

there is

$$ℙ [ {sup}_{π , i} \vert {h}^{i} ( π ) - {\hat{h}}^{i} ( π ) \vert < ϵ ] \geq 1 - δ .$$

Plugging the result into Eq. (101), it can be obtained:

$${max}_{{π}^{i}} {𝔼}_{{π}^{- i} \sim {x}^{- i}} [ {h}^{i} ( {π}^{i} , {π}^{- i} ) ] - {𝔼}_{π \sim x} [ {h}^{i} ( π ) ] \leq 2 ϵ \qquad ( 124 )$$

### Adversarial Variance Reduced Q-Learning

In some embodiments, another Q-Learning algorithm is provided. The system may receive input data including training epochs T; environment env; adversarial action schedule X; exploration rate ϵ; number of models k; epoch length K, recentering sample sizes {Nₘ}_{m≥1}; utility function parameter for protagonist β^{P}<0; and utility function parameter for adversary β^{A}>0. The training system may initialize Q̅₀^{P}=0; Q̅₀^{A}=0; m_{P}=1; B=0 ∈

[symbol]

From t=1 to T, for each value of t: the system chooses Agent g from {A; P} according to X. Select action aₜ according to Q̅ₘ_{_{g}}₋₁^{g} by applying ϵ-greedy strategy. The system executes the selected action and get (sₑ,aₑ, obs, reward, done); set RB_{g}=RB_{g}∪{(sₑ,aₑ, obs, reward, done)}.

From i=1, N for each value of i: the system defines

$${\hat{𝒥}}_{i} ( Q ) ( s , a ) = r + {γ}^{n} \cdot {max}_{{a}^{′}} Q ( {s}^{′} , {a}^{′} )$$

where r is the reward of agent g, e.g., r_{P} (s, a)=r (s, a)+Σᵢ₌ⱼⁿγ^{j}r (sⱼ^{A}, aⱼ^{A}), aⱼ^{A} are selected according to Q̅ₘ_{_{A}}^{A}, and sⱼ^{A}, s′ are sampled from the MDP, and [symbol] are empirical Bellman operators constructed using independent samples. The system sets g=P and defines

$${\tilde{𝒥}}_{N} ( {\overline{Q}}_{{m}_{P} - 1}^{P} ) = \frac{1}{N} {\sum }_{i ∈ {𝒟}_{N}} {\hat{𝒥}}_{i} ( {\overline{Q}}_{{m}_{P} - 1}^{P} ) ,$$

where [symbol] _{N} is a collection of N i.i.d. samples (i.e., matrices with samples for each state-action pair (s, a) from RB_{P}); and sets Q₁^{P}=Q̅ₘ_{_{g}}₋₁^{P}.

From k=1, . . . , K for each value of k: the system computes stepsize λₖ=1/1+(1−γ)k and updates:

Qₖ₊₁^{g}←(1−λₖ)·Qₖ^{g}+λk·[ [symbol] (Qₖ^{g})− [symbol] (Q̅ₘ_{_{g}}₋₁^{g})+ [symbol] (Q̅ₘ_{_{g}}₋₁^{g})],

where [symbol] is empirical Bellman operator constructed using a sample not in [symbol] _{N}, thus the random operators [symbol] and [symbol] are independent.

Then the system sets Q̅ₘ_{_{g}}^{g}=Q_{K+1}^{g}, m_{g}=m_{g}+1, g=A.

From k=1, . . . , K for each value of k: the system computes

$$\begin{matrix}B ( {s}_{{m}_{A}} , {a}_{{m}_{A}} ) = B ( {s}_{{m}_{A}} , {a}_{{m}_{A}} ) + 1 \\ {α}_{{m}_{A}} = \frac{1}{B ( {s}_{{m}_{A}} , {a}_{{m}_{A}} )} \\ {Q}_{{m}_{A}}^{A} ← ( 1 - {α}_{{m}_{A}} ) \cdot {Q}_{{m}_{A}}^{A} + {α}_{{m}_{A}} \cdot \hat{𝒥} ( {Q}_{{m}_{A}}^{A} )\end{matrix} \qquad ( 126 )$$

$${max}_{{a}_{P}} {Q}^{P} ( s , {a}_{P} ) = {max}_{{a}_{P}} {max}_{{a}_{A}} {Q}^{P} ( s , {a}_{P} , {a}_{A} ) = {max}_{{a}_{P}} {min}_{{a}_{A}} {Q}^{P} ( s , {a}_{P} , {a}_{A} )$$

Then policies (π^{P}*, π^{A}*) are obtained:

J^{P}(s,Q^{P}*,Q^{A}*)= [symbol] [Σγ^{t}·rₜ^{P}|s,π_{*}^{P},π^{A}*] (127)

i.e., for any other policy π^{P},

[symbol]

[Σγ^{t}·rₜ^{P}|s,π^{P}*,π^{A}*]≥ [symbol] [Σγ^{t}·rₜ^{P}|s,π^{P},π^{A}*] (128)

for any other policy π^{A},

[symbol]

[Σγ^{t}·rₜ^{A}|s,π^{P}*,π^{A}*]≥ [symbol] [Σγ^{t}·rₜ^{A}|s,π^{P}*,π^{A}] (129)

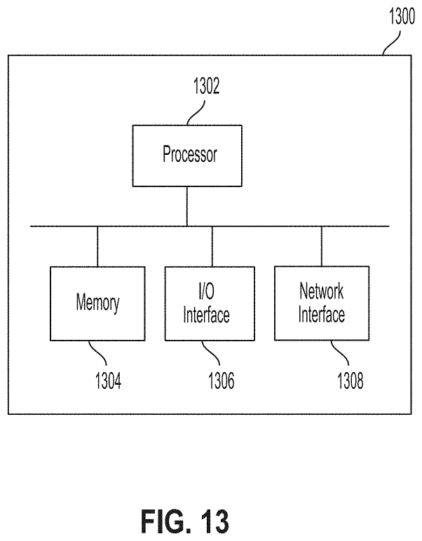

FIG. 13 is a schematic diagram of another example computing device 1300 that implements a system (e.g., the training engine 112 on trade platform 100) for training an automated agent having a neural network, in accordance with an embodiment. As depicted, computing device 1300 includes one or more processors 1302, memory 1304, one or more I/O interfaces 1306, and, optionally, one or more network interfaces 1308.

Each processor 1302 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 1304 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1304 may store code executable at processor 1302, which causes training system to function in manners disclosed herein. Memory 1304 includes a data storage. In some embodiments, the data storage includes a secure datastore. In some embodiments, the data storage stores received data sets, such as textual data, image data, or other types of data.

Each I/O interface 1306 enables computing device 1300 to interconnect with one or more input devices, such as a keyboard, mouse, camera, touch screen and a microphone, or with one or more output devices such as a display screen and a speaker.

Each network interface 1308 enables computing device 1300 to communicate with other components, to exchange data with other components, to access and connect to network resources, to serve applications, and perform other computing applications by connecting to a network such as network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The methods disclosed herein may be implemented using a system that includes multiple computing devices 1300. The computing devices 1300 may be the same or different types of devices.

Each computing devices may be connected in various ways including directly coupled, indirectly coupled via a network, and distributed over a wide geographic area and connected via a network (which may be referred to as “cloud computing”).

For example, and without limitation, each computing device 1300 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods described herein.

Embodiments performing the operations for anomaly detection and anomaly scoring provide certain advantages over manually assessing anomalies. For example, in some embodiments, all data points are assessed, which eliminates subjectivity involved in judgement-based sampling, and may provide more statistically significant results than random sampling. Further, the outputs produced by embodiments of system are reproducible and explainable.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

### REFERENCES

[1] Anschel, Oron and Baram, Nir and Shimkin, Nahum. Averaged-dqn: Variance reduction and stabilization for deep reinforcement learning. International Conference on Machine Learning, pages 176-185, 2017. PMLR.
[2] Bagherzadeh, Mojtaba and Kahani, Nafiseh and Briand, Lionel. Reinforcement Learning for Test Case Prioritization. arXiv preprint arXiv:2011.01834, 2020.
[3] Balch, Tucker Hybinette and Mahfouz, Mahmoud and Lockhart, Joshua and Hybinette, Maria and Byrd, David. How to Evaluate Trading Strategies: Single Agent Market Replay or Multiple Agent Interactive Simulation?. arXiv preprint arXiv:1906.12010, 2019.
[4] Bellemare, Marc G and Candido, Salvatore and Castro, Pablo Samuel and Gong, Jun and Machado, Marlos C and Moitra, Subhodeep and Ponda, Sameera S and Wang, Ziyu. Autonomous navigation of stratospheric balloons using reinforcement learning. Nature, 588(7836):77-82, 2020.
[5] Berner, Christopher and Brockman, Greg and Chan, Brooke and Cheung, Vicki and Debiak, Przemyslaw and Dennison, Christy and Farhi, David and Fischer, Quirin and Hashme, Shariq and Hesse, Chris and others. Dota 2 with large scale deep reinforcement learning. arXiv preprint arXiv:1912.06680, 2019.
[6] Bertsekas, Dimitri P. Neuro-dynamic programming Neuro-Dynamic Programming, pages 2555-2560. Springer US, Boston, Mass., 2009.
[7] Bloembergen, Daan and Hennes, Daniel and McBurney, Peter and Tuyls, Karl. Trading in markets with noisy information: An evolutionary analysis. Connection Science, 27(3):253-268, 2015.
[8] Bowling, Michael. Convergence problems of general-sum multiagent reinforcement learning. ICML, pages 89-94, 2000.
[9] Bowling, Michael and Veloso, Manuela. Multiagent learning using a variable learning rate. Artificial Intelligence, 136(2):215-250, 2002.
[10] Buldygin, V. V. and Kozachenko, Yu. V. Sub-Gaussian random variables. Ukrainian Mathematical Journal, 32(6):483-489, 1980.
[11] Byrd, David and Hybinette, Maria and Balch, Tucker Hybinette. Abides: Towards high-fidelity market simulation for ai research. arXiv preprint arXiv:1904.12066, 2019.
[12] Di Castro, Dotan and Tamar, Aviv and Mannor, Shie. Policy gradients with variance related risk criteria. arXiv preprint arXiv:1206.6404, 2012.
[13] Filar, J. and Vrieze, K. Competitive Markov Decision Processes. Springer, 1997.
[14] Garcia, Javier and Fernandez, Fernando. A comprehensive survey on safe reinforcement learning. Journal of Machine Learning Research, 16(1):1437-1480, 2015.
[15] Henderson, Peter and Islam, Riashat and Bachman, Philip and Pineau, Joelle and Precup, Doina and Meger, David. Deep reinforcement learning that matters. Proceedings of the AAAI Conference on Artificial Intelligence, number 1, 2018.
[16] Hu, Junling and Wellman, Michael P. Multiagent Reinforcement Learning: Theoretical Framework and an Algorithm. Proceedings of the Fifteenth International Conference on Machine Learning in ICML '98, pages 242-250, San Francisco, Calif., USA, 1998. Morgan Kaufmann Publishers Inc.
[17] Johnson, Rie and Zhang, Tong. Accelerating Stochastic Gradient Descent using Predictive Variance Reduction. In C. J. C. Burges and L. Bottou and M. Welling and Z. Ghahramani and K. Q. Weinberger, editors, Advances in Neural Information Processing Systems, 2013. Curran Associates, Inc.
[18] Li, Yuxi. Deep reinforcement learning: An overview. arXiv preprint arXiv:1701.07274, 2017.
[19] Li, Yuxi and Szepesvari, Csaba and Schuurmans, Dale. Learning exercise policies for american options. Artificial Intelligence and Statistics, pages 352-359, 2009. PMLR.
[20] Littman, Michael L. Value-function reinforcement learning in Markov games. Cognitive systems research, 2(1):55-66, 2001.
[21] Mihatsch, Oliver and Neuneier, Ralph. Risk-sensitive reinforcement learning. Machine learning, 49(2):267-290, 2002.
[22] Mirhoseini, Azalia and Goldie, Anna and Yazgan, Mustafa and Jiang, Joe and Songhori, Ebrahim and Wang, Shen and Lee, Young-Joon and Johnson, Eric and Pathak, Omkar and Bae, Sungmin and others. Chip placement with deep reinforcement learning. arXiv preprint arXiv:2004.10746, 2020.
[23] Morimoto, Jun and Doya, Kenji. Robust reinforcement learning. Neural computation, 17(2):335-359, 2005.
[24] Ning, Brian and Lin, Franco Ho Ting and Jaimungal, Sebastian. Double deep q-learning for optimal execution. arXiv preprint arXiv:1812.06600, 2018.
[25] Pan, Xinlei and Seita, Daniel and Gao, Yang and Canny, John. Risk averse robust adversarial reinforcement learning. 2019 International Conference on Robotics and Automation (ICRA), pages 8522-8528, 2019. IEEE.
[26] Pinto, Lerrel and Davidson, James and Sukthankar, Rahul and Gupta, Abhinay. Robust adversarial reinforcement learning. International Conference on Machine Learning, pages 2817-2826, 2017. PMLR.
[27] Sharpe, William F. The sharpe ratio. Journal of portfolio management, 21(1):49-58, 1994.
[28] Shen, Yun and Tobia, Michael J and Sommer, Tobias and Obermayer, Klaus. Risk-sensitive reinforcement learning. Neural computation, 26(7):1298-1328, 2014.
[29] Spooner, Thomas and Fearnley, John and Savani, Rahul and Koukorinis, Andreas. Market making via reinforcement learning. arXiv preprint arXiv:1804.04216, 2018.
[30] SzepesvÃᵢri, Csaba and Littman, Michael. A Unified Analysis of Value-Function-Based Reinforcement-Learning Algorithms. Neural computation, 11:2017-59, 1999.
[31] Théate, Thibaut and Ernst, Damien. An application of deep reinforcement learning to algorithmic trading. Expert Systems with Applications, 173:114632, 2021.
[32] Tobia, M. J. and Guo, Rong and Schwarze, U and Bohmer, Wendelin and Glascher, Jan and Finckh, Barbara and Marschner, A and Buchel, C and Obermayer, Klaus and Sommer, Tobias. Neural Systems for Choice and Valuation with Counterfactual Learning Signals. NeuroImage, 89, 2013.
[33] Tuyls, Karl and Perolat, Julien and Lanctot, Marc and Hughes, Edward and Everett, Richard and Leibo, Joel Z and Szepesvari, Csaba and Graepel, Thore. Bounds and dynamics for empirical game theoretic analysis. Autonomous Agents and Multi-Agent Systems, 34(1):1-30, 2020.
[34] Wainwright, Martin J. Variance-reduced Q-learning is minimax optimal. arXiv preprint arXiv:1906.04697, 2019.
[35] Walsh, William E and Das, Rajarshi and Tesauro, Gerald and Kephart, Jeffrey O. Analyzing complex strategic interactions in multi-agent systems. AAAI-02 Workshop on Game-Theoretic and Decision-Theoretic Agents, pages 109-118, 2002.
[36] Weibull, Jörgen W. Evolutionary game theory. MIT press, 1997.
[37] Weinberg, Michael and Rosenschein, Jeffrey S. Best-response multiagent learning in non-stationary environments. Proceedings of the Third International Joint Conference on Autonomous Agents and Multiagent Systems—Volume 2, pages 506-513, 2004
[38] Wellman, Michael P. Methods for empirical game-theoretic analysis. AAAI, pages 1552-1556, 2006.

1. A computer-implemented system for training an automated agent, the system comprising:
a communication interface;
at least one processor;
memory in communication with said at least one processor;
software code stored in said memory, which when executed at said at least one processor causes said system to:
instantiate an automated agent that maintains a reinforcement learning neural network and generates, according to outputs of said reinforcement learning neural network, signals for communicating task requests;
receive, by way of said communication interface, a plurality of training input data including a plurality of states and a plurality of actions for the automated agent;
initialize a learning table Q for the automated agent based on the plurality of states and the plurality of actions;
compute a plurality of updated learning tables based on the initialized learning table Q using a utility function, the utility function comprising a monotonically increasing concave function; and
generate an averaged learning table Q′ based on the plurality of updated learning tables.

2. The computer-implemented system of claim 1, wherein said automated agent is configured to select an action based on the averaged learning table Q′ for communicating one or more task requests.

3. The computer-implemented system of claim 1, wherein the utility function is represented by u(x)=−e^{βx}, β<0.

4. The computer-implemented system of claim 1, wherein computing a plurality of updated learning tables comprises:
receiving, by way of said communication interface, an input parameter k and a training step parameter T; and
for each training step t, where t=1, 2 . . . T:
computing an interim learning table \hat{Q} based on the initialized learning table Q;
selecting an action aₜ from the plurality of actions based on the interim learning table \hat{Q} and a given state sₜ from the plurality of states;
computing a reward rₜ and a next state sₜ₊₁ based on the selected action aₜ; and
for at least two values of i, where i=1, 2, . . . , k, computing a respective updated learning table Qⁱ of the plurality of updated learning tables based on (sₜ,aₜ,rₜ,sₜ₊₁) and the utility function.

5. The computer-implemented system of claim 4, wherein the averaged learning table Q′ is computed as
$$\frac{1}{k} {\sum }_{i = 1}^{k} {Q}^{i} .$$

6. The computer-implemented system of claim 1, wherein the utility function is a first utility function, and wherein the software code, when executed at said at least one processor, further causes said system to:
instantiate an adversarial agent that maintains an adversarial reinforcement learning neural network and generates, according to outputs of said adversarial reinforcement learning neural network, signals for communicating adversarial task requests;
initialize an adversarial learning table Q_{A} for the adversarial agent;
compute a plurality of updated adversarial learning tables based on the initialized adversarial learning table Q_{A} using a second utility function, the second utility function comprising a monotonically increasing convex function; and
generate an averaged adversarial learning table Q_{A}′ based on the plurality of updated adversarial learning tables.

7. The computer-implemented system of claim 6, wherein said adversarial agent is configured to select an adversarial action based on the averaged adversarial learning table Q_{A}′ to minimize a reward for the automated agent.

8. The computer-implemented system of claim 6, wherein the second utility function is represented by u^{A}(x)=−e^{β}^{^{A}}^{x}, β^{A}>0.

9. The computer-implemented system of claim 6, wherein computing a plurality of updated adversarial learning tables comprises:
receiving, by way of said communication interface, an input parameter k and a training step parameter T; and
for each training step t, where t=1, 2 . . . T:
computing an interim adversarial learning table \hat{Q}_{A} based on the initialized adversarial learning table Q^{A};
selecting an adversarial action aₜ^{A} based on the interim adversarial learning table \hat{Q}_{A} and a given state sₜ from the plurality of states;
computing an adversarial reward rₜ^{A} and a next state sₜ₊₁ based on the selected adversarial action aₜ^{A}; and
for at least two values of i, where i=1, 2, . . . , k, computing a respective updated adversarial learning table Qⁱ_{A} of the plurality of updated adversarial learning tables based on (sₜ,aₜ^{A},rₜ^{A},sₜ₊₁) and the second utility function.

10. The computer-implemented system of claim 9, wherein the averaged adversarial learning table Q_{A}′ is computed as
$$\frac{1}{k} {\sum }_{i = 1}^{k} {{Q}^{i}}_{A} .$$

11. A computer-implemented method of training an automated agent, the method comprising:
instantiating an automated agent that maintains a reinforcement learning neural network and generates, according to outputs of said reinforcement learning neural network, signals for communicating task requests;
receiving, by way of said communication interface, a plurality of training input data including a plurality of states and a plurality of actions for the automated agent;
initializing a learning table Q for the automated agent based on the plurality of states and the plurality of actions;
computing a plurality of updated learning tables based on the initialized learning table Q using a utility function, the utility function comprising a monotonically increasing concave function; and
generating an averaged learning table Q′ based on the plurality of updated learning tables.

12. The method of claim 11, further comprising selecting an action, by the automated agent, based on the averaged learning table Q′ for communicating one or more task requests.

13. The method of claim 11, wherein the utility function is represented by u(x)=−e^{βx}, β<0.

14. The method of claim 11, wherein computing a plurality of updated learning tables comprises:
receiving, by way of said communication interface, an input parameter k and a training step parameter T; and
for each training step t, where t=1, 2 . . . T:
computing an interim learning table \hat{Q} based on the initialized learning table Q;
selecting an action aₜ from the plurality of actions based on the interim learning table \hat{Q} and a given state sₜ from the plurality of states;
computing a reward rₜ and a next state sₜ₊₁ based on the selected action aₜ; and
for at least two values of i, where i=1, 2, . . . , k, computing a respective updated learning table Qⁱ of the plurality of updated learning tables based on (sₜ,aₜ,rₜ,sₜ₊₁) and the utility function.

15. The method of claim 14, wherein the averaged learning table Q′ is computed as
$$\frac{1}{k} {\sum }_{i = 1}^{k} {Q}^{i} .$$

16. The method of claim 11, wherein the utility function is a first utility function and further comprising:
instantiating an adversarial agent that maintains an adversarial reinforcement learning neural network and generates, according to outputs of said adversarial reinforcement learning neural network, signals for communicating adversarial task requests;
initializing an adversarial learning table Q_{A} for the adversarial agent;
computing a plurality of updated adversarial learning tables based on the initialized adversarial learning table Q_{A} using a second utility function, the second utility function comprising a monotonically increasing convex function; and
generating an averaged adversarial learning table Q_{A}′ based on the plurality of updated adversarial learning tables.

17. The method of claim 16, further comprising selecting an adversarial action, by the adversarial agent, based on the averaged adversarial learning table Q_{A}′ to minimize a reward for the automated agent.

18. The method of claim 16, wherein the second utility function is represented by u^{A}(x)=−e^{β}^{^{A}}^{x}, β^{A}>0.

19. The method of claim 16, wherein computing a plurality of updated adversarial learning tables comprises:
receiving, by way of said communication interface, an input parameter k and a training step parameter T; and
for each training step t, where t=1, 2 . . . T:
computing an interim adversarial learning table \hat{Q}^{A} based on the initialized adversarial learning table Q^{A};
selecting an adversarial action aₜ^{A} based on the interim adversarial learning table \hat{Q}^{A} and a given state sₜ from the plurality of states;
computing an adversarial reward rₜ^{A} and a next state sₜ₊₁ based on the selected adversarial action aₜ^{A}; and
for at least two values of i, where i=1, 2, . . . , k, computing a respective updated adversarial learning table Qⁱ_{A} of the plurality of updated adversarial learning tables based on (sₜ,aₜ^{A},rₜ^{A},sₜ₊₁) and the second utility function.

20. The method of claim 19, wherein the averaged adversarial learning table Q_{A}′ is computed as
$$\frac{1}{k} {\sum }_{i = 1}^{k} {{Q}^{i}}_{A} .$$
